(19) United States
(12) Patent Application Publication
(10) Pub. No.: US 2010/0080629 A1
(43) Pub. Date: Apr. 1, 2010

(54) METHOD FOR MANUFACTURING TONER, TONER, DEVELOPER, DEVELOPING APPARATUS, AND IMAGE FORMING APPARATUS

(76) Inventors: Takashi HARA, Osaka (JP); Yoshitaka Kawase, Osaka (JP); Yoshiaki Akazawa, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/569,458

(22) Filed: Sep. 29, 2009

(30) Foreign Application Priority Data
Sep. 29, 2008 (JP) P2008-251887

(51) Int. Cl. G03G 15/08; G03G 9/08; G03G 9/093

(52) U.S. Cl. 399/252; 430/137.11; 430/110.2

(57) ABSTRACT

A method for manufacturing a toner is provided. In a fine resin particle adhering step S1b, fine resin particles adhere to toner base particle surfaces in a powder passage. In a spraying step S3c, flowing toner base particles and fine resin particles are sprayed with a substance in liquid form for plasticizing those particles. In a film-forming step S3d, toner base particles and fine resin particles are circulated repeatedly in the powder passage until fine resin particles adherent to toner base particles are shaped into a film. In the spraying step S3c, the substance in liquid form is sprayed in such a manner that the LEL concentration coefficient within the powder passage falls in a range of from 0.07 to 8.12.

### CROSS-REFERENCE TO RELATED APPLICATION

This application claims priority to Japanese Patent Application No. 2008-251887, which was filed on Sep. 29, 2008, the contents of which are incorporated herein by reference in their entirety.

### BACKGROUND OF THE INVENTION

1. Field of the Invention

The present invention relates to a method for manufacturing a toner, a toner, a developer, a developing device, and an image forming apparatus.

2. Description of the Related Art

With the aim of achieving enhancement in the characteristics of powder particles such as toner particles, heretofore it has been customary to perform surface reforming treatment on powder particles. That is, the surfaces of powder particles are coated with a coating material. In connection therewith studies and researches have been under way to come up with methods for allowing tight adhesion and fixation of a coating material onto powder particles.

As a method for the surface modification treatment of the powder particles such as toner particles, a method is known that a mechanical stirring force is applied to the powder particles by a rotary stirring section such as a screw, a blade, or a rotor to fluidize the powder particles in a powder flowing passage and a coating material is ejected from a spray nozzle to the powder particles in a fluidized state. For example, Japanese Examined Patent Publication JP-B2 5-10971 (1993) discloses a surface modification method of solid particles in which a rotary stirring section is rotated at peripheral speed of 5 to 160 m/sec to fluidize powder particles and a liquid is sprayed from a spray nozzle to the powder particles in a fluidized state to adhere fine solid particles contained in the liquid to surface of the powder particles or to form a film of a coating material contained in the liquid on the surface of the power particles. According to the surface modification method disclosed in JP-B2 5-10971, adhesiveness between the coating material and the powder particles is able to be improved and time required for the surface modification treatment is able to be shortened.

Further, Japanese Unexamined Patent Publication JP-A 4-211269 (1992) discloses a method for manufacturing a microcapsule in which resin particles are adhered to the surface of inner core particles and are treated with a solvent that dissolves the resin particles to form a coating layer on the surface of the inner core particles. The method for manufacturing a microcapsule disclosed in JP-A 4-211269 comprises at least a step of adhering the resin particles to the surface of the inner core particles, a step of treating resin particles with a solvent that dissolves the resin particles, and a step of drying and collecting the treated particles.

However, the method disclosed in JP-B2 5-10971 poses the following problems. According to this method, powder particles are caused to flow under the mechanical stirring force applied by the rotary stirring section, and the powder particles in a fluidized state are sprayed with a liquid containing the coating material by means of the spray nozzle, whereby coated powder particles are formed. In order to obtain powder particles coated uniformly and fixedly with the coating material, where the concentration of the coating material contained in the spray liquid is low, there arises a need to increase the amount of the spray liquid to apply the coating material uniformly onto the powder material. This is causative of easy adhesion of the powder particles to the inner walls of the apparatus. Should this occur, in the presence of the adherent powder particle acting as a core, other powder particles and coating material portions could undergo aggregation growth. In the event of the aggregation growth of the powder particles and coating material portions at the inner walls of the apparatus, the flow passage through which the powder particles flow becomes so narrow that there arise the problem of a hindrance to the isolative flowing actions of the powder particles and the problem of a decline in the yields of the coated particles. Furthermore, unless the liquid which contains the coating material is selected properly, there will be a liquid buildup within the apparatus and the liquid may adsorb to the powder particles, which results in development of aggregates. This could lead to adhesion of the aggregates to the inner wall surfaces of the apparatus. In addition, there is the possibility of giving rise to lack of uniformity in a film formed from fine resin particles when the liquid is dried. It is, after all, difficult to determine suitable manufacturing conditions for bringing out toner performance capabilities under the current state of the art.

On the other hand, according to the method disclosed in JP-A 4-211269, a solvent which dissolves the resin constituting the resin particles is used for the treatment. In this case, the solvent confined in the resin of the resin particles is difficult to evaporate, in consequence whereof there result large amounts of aggregates. Furthermore, since many adherents are present at the inner wall surfaces of the apparatus, it will be difficult to collect particles in a primary particle state. This leads to poor productivity. In order to avoid such a problem, it is necessary to choose, as the solvent for use, a solvent characterized by being capable of dissolving a coating material but incapable of dissolving inner core particles. However, the selection of a suitable solvent-resin combination which serves the intended purpose will be difficult. In addition, in order to effect film-thickness adjustment, there is a need to increase the amount of the coating material by performing heavy spray treatment. Fulfillment of such a requirement will exacerbate the problem of aggregation.

### SUMMARY OF THE INVENTION

Hence, an object of the invention is to provide a method for manufacturing a toner that allows production of a toner composed of toner base particles whose surfaces are coated with fine resin particles in the form of a uniform film while suppressing development of aggregation by fostering filmization of the fine resin particles adherent to the toner base particle surfaces, as well as to provide a toner manufactured by the manufacturing method, a developer containing the toner, a developing apparatus which employs the developer, and an image forming apparatus.

The invention provides a method for manufacturing a toner comprising:

a fine resin particle adhering step of putting toner base particles and fine resin particles into a powder passage with a rotary stirring section in a rotating state, so that the fine resin particles adhere to the surfaces of the toner base particles;

a spraying step of spraying the toner base particles and the fine resin particles in a fluidized state with a substance in liquid form capable of plasticizing those particles in the presence of a carrier gas by means of a spraying section; and

a film-forming step of rotating the rotary stirring section continuously to circulate the toner base particles and the fine resin particles repeatedly within the powder passage until the fine resin particles adherent to the toner base particles are changed to a film state,

the spraying section squirting the substance in liquid form in the spraying step in such a manner that an LEL concentration coefficient X within the powder passage fulfills the following formula (1):

0.07≦X≦8.12 (1)

wherein

the LEL concentration coefficient X is represented in expression form as follows:

X={(Gasification volume of substance in liquid form to be sprayed per unit of time)/(Powder passage interior volume)}×100/(LEL concentration of substance in liquid form), the substance-in-liquid-form LEL concentration being indicative of a lower explosive limit concentration of the substance in liquid form in a gasified state under predetermined conditions.

According to the invention, there is provided the method for manufacturing a toner involving the fine resin particle adhering step, the spraying step, and the film-forming step. In the fine resin particle adhering step, toner base particles and fine resin particles are put into the powder passage with the rotary stirring section in a rotating state, so that the fine resin particles adhere to the surfaces of the toner base particles. In the spraying step, the toner base particles and the fine resin particles in a fluidized state are sprayed with a substance in liquid form capable of plasticizing those particles in the presence of a carrier gas by means of the spraying section. In the film-forming step, the rotary stirring section is rotated continuously to circulate the toner base particles and the fine resin particles repeatedly within the powder passage until the fine resin particles adherent to the toner base particles are changed to a film state. At this time, in the spraying step, the substance in liquid form is sprayed by the spraying section in such a manner that the LEL (Lower Explosive Limit) concentration coefficient within the powder passage falls in a range of from 0.07 and above to 8.12 and below. As employed herein, the LEL concentration coefficient X is representable in expression form as: X={(Gasification volume of substance in liquid form to be sprayed per unit of time)/(Powder passage interior volume)}×100/(LEL concentration of substance in liquid form). The substance-in-liquid-form LEL concentration is indicative of the lower explosive limit concentration of the substance in liquid form in a gasified state under predetermined conditions.

In the spraying step, the substance in liquid form is sprayed in such a manner that the LEL concentration coefficient within the powder passage is greater than or equal to 0.07. In this way, the gas concentration of the substance in liquid form gasified within the powder passage stands at a level high enough to plasticize the toner base particles and the fine resin particles. Then, in the film-forming step, the toner base particles and the fine resin particles are circulated repeatedly along with the substance in liquid form having a gas concentration high enough to plasticize the toner base particles and the fine resin particles within the powder passage. This makes it possible to foster the filmization of the fine resin particles adherent to the toner base particles, and thereby produce a toner composed of the toner base particles whose surfaces are uniformly coated with a film of the fine resin particles.

Moreover, in the spraying step, the substance in liquid form is sprayed in such a manner that the LEL concentration coefficient within the powder passage is smaller than or equal to 8.12. In this way, the substance in liquid form sprayed into the powder passage can be prevented from remaining in the form of droplets in the system without undergoing gasification. This makes it possible to avoid development of aggregates resulting from adsorption of the liquid droplets on the toner base particles and the fine resin particles circulating within the powder passage, and thereby produce a toner composed of the toner base particles whose surfaces are uniformly coated with a film of the fine resin particles in a high yield.

In the invention, it is preferable that the toner manufacturing is performed by using a rotary stirring device comprising: a circulation section for effecting repeated circulation of the toner base particles and the fine resin particles within the powder passage including a rotary stirring chamber and a circulating tube and return of those particles to the rotary stirring chamber by means of a rotary stirring section including a rotary disc with rotating vanes installed therearound and a rotary shaft; a temperature regulation section provided in at least a part of the powder passage, for regulating the temperatures of the interior of the powder passage and the rotary stirring section to predetermined temperatures; and a spraying section, and

in the fine resin particle adhering step, the spraying step, and the film-forming step, the temperatures of the interior of the powder passage and the rotary stirring section are regulated to the predetermined temperatures by the temperature regulation section.

According to the invention, toner manufacturing is performed by using the rotary stirring device comprising: the circulation section for effecting repeated circulation of the toner base particles and the fine resin particles within the powder passage including the rotary stirring chamber and the circulating tube and return of those particles to the rotary stirring chamber by means of the rotary stirring section including the rotary disc with rotating vanes installed therearound and the rotary shaft; the temperature regulation section provided in at least a part of the powder passage, for regulating the temperatures of the interior of the powder passage and the rotary stirring section to predetermined temperatures; and the spraying section. In the fine resin particle adhering step, the spraying step, and the film-forming step, the temperatures of the interior of the powder passage and the rotary stirring section are regulated to the predetermined temperatures by the temperature regulation section. This makes it possible to suppress adhesion of the toner base particles and the fine resin particles to the inner wall of the powder passage resulting from an excessive temperature rise, and thereby prevent the interior of the powder passage from narrowing due to the adhesion of the toner base particles and the fine resin particles. Accordingly, a toner composed of the toner base particles whose surfaces are uniformly coated with a film of the fine resin particles can be manufactured in a high yield.

Moreover, in the invention, it is preferable that the substance in liquid form which is sprayed in the spraying step is an alcohol having an LEL concentration in a range of from 1.4% to 6.7% by volume.

According to the invention, the substance in liquid form which is sprayed in the spraying step is an alcohol having an LEL concentration in a range of from 1.4% to 6.7% by volume. In the case of using an alcohol whose LEL concentration is lower than 1.4% by volume, the ability of the alcohol to plasticize the toner base particles and the fine resin particles is so poor that the fine resin particles are unable to change to a film state on the surfaces of the toner base particles at a desired pace. Therefore, too long a time needs to be spent in filmization of the fine resin particles. This leads to undesirable deformation and mutual aggregation of toner particles, which renders it impossible to obtain a toner having desired particle shape and size in a high yield. By contrast, in the case of using an alcohol whose LEL concentration is higher than 6.7% by volume, the toner base particles and the fine resin particles are excessively plasticized, in consequence whereof there result mutual tight adhesion and aggregation among the toner base particles or the fine resin particles. This renders it impossible to obtain a toner having a desired particle size in a high yield.

Moreover, in the invention, it is preferable that the substance in liquid form is a low-grade alcohol in which a number of carbon in a molecule is 3 or below.

According to the invention, the substance in liquid form which is sprayed in the spraying step is a low-grade alcohol in which a number of carbon in a molecule is 3 or below. The use of such an alcohol makes it possible to enhance the wettability of the fine resin particles provided as a coating material with respect to the surfaces of the toner base particles, to allow the fine resin particles to adhere to the entire or most part of the surfaces of the toner base particles, and to facilitate the change in shape and filmization of the fine resin particles. As another advantage, since such a low-grade alcohol has a high vapor pressure, its use makes it possible to shorten the time of drying required for substance-in-liquid-form removal, and thereby suppress mutual aggregation among the toner base particles.

The invention provides a toner manufactured by the method for manufacturing a toner as set forth hereinabove.

According to the invention, the toner according to the invention is manufactured by the method for manufacturing a toner of the invention. That is, the toner is composed of toner base particles having on their surfaces a resin coating layer made of fine resin particles in the form of a uniform film. Since the fine resin particles are changed to a uniform film state thereby to form the resin coating layer, it follows that the individual toner particles are uniform in toner characteristics such as a charging characteristic. Moreover, in the toner of the invention, the resin coating layer borne on the toner surface produces an inclusion-component protection effect. Accordingly, even if a material having a low melting point is used for the toner base particles, storage stability deterioration can be avoided. By performing image formation with use of such a toner, it is possible to form a good-quality image which exhibits high resolution and is free from unevenness in image density with stability.

Moreover, the invention provides a developer comprising the toner mentioned above.

According to the invention, the developer contains the toner of the invention and is thus characterized in that the individual toner particles contained therein are uniform in toner characteristics such as a charging characteristic. Therefore, a developer which is capable of sustaining satisfactory development performance can be obtained. Moreover, in the developer, even if a material having a low melting point is used for the toner base particles, storage stability deterioration can be avoided. Accordingly, the developer, even when used in a high-temperature atmosphere, suffers little from flowability deterioration. It is thus possible to obtain a developer which is capable of sustaining satisfactory development performance.

Moreover, in the invention, it is preferable that the developer further comprises a carrier and constitutes a two-component developer.

According to the invention, the developer is a two-component developer which comprises the toner mentioned above and a carrier. Since the two-component developer contains the toner in which storage stability deterioration can be avoided even with use of a material having a low melting point for the toner base particles, it is possible to prevent deterioration in the charge imparting capability of the carrier resulting from occurrence of toner-spent on the carrier. It is thus possible to obtain a two-component developer which is capable of sustaining satisfactory development performance.

Moreover, the invention provides a developing device that develops a latent image formed on an image bearing member to form a toner image using the developer mentioned above.

According to the invention, the developing apparatus develops a latent image by using the developer of the invention, and is thus capable of forming a high-resolution, density unevenness-free good toner image on an image carrier with stability. Accordingly, a high-quality image can be formed with stability.

Moreover, the invention provides an image forming apparatus, comprising:

an image bearing member on which a latent image is to be formed;

a latent image forming section for forming the latent image on the image bearing member; and

the developing device mentioned above.

According to the invention, an image forming apparatus is realized by comprising an image bearing member on which a latent image is to be formed; a latent image forming section for forming the latent image on the image bearing member; and the developing device capable of forming the toner image having high definition without unevenness in density as described above. By forming an image by such an image forming apparatus, it is possible to stably form an image that has high definition and high image quality without unevenness in density.

### BRIEF DESCRIPTION OF THE DRAWINGS

Other and further objects, features, and advantages of the invention will be more explicit from the following detailed description taken with reference to the drawings wherein:

FIG. 1 is a flowchart of an example of a procedure for a method for manufacturing a toner according to an embodiment;

FIG. 2 is a front view of a configuration of a toner manufacturing apparatus used for the method for manufacturing a toner according to the embodiment of the invention;

FIG. 3 is a schematic sectional view of the toner manufacturing apparatus shown in FIG. 2 taken along the cross-sectional line A200-A200;

FIG. 4 is a front view of a configuration around the powder inputting section and the powder collecting section;

FIG. 5 is a view showing a configuration of an image forming apparatus according to an embodiment of the invention; and

FIG. 6 is a view showing a configuration of the developing device provided in the image forming apparatus.

### DETAILED DESCRIPTION

Now referring to the drawings, preferred embodiments of the invention will be described in detail.

1. Method for Manufacturing Toner

A method for manufacturing a toner according to the invention involves a fine resin particle adhering step, a spraying step, and a film-forming step. In the fine resin particle adhering step, toner base particles and fine resin particles are put into a powder passage with a rotary stirring section in a rotating state, so that the fine resin particles adhere to the surfaces of the toner base particles. In the spraying step, the toner base particles and the fine resin particles in a fluidized state are sprayed with a substance in liquid form capable of plasticizing those particles in the presence of a carrier gas by means of a spraying section. In the film-forming step, the rotary stirring section is rotated continuously to circulate the toner base particles and the fine resin particles repeatedly within the powder passage until the fine resin particles adherent to the toner base particles are changed to a film state. Moreover, it is preferable that, in the fine resin particle adhering step, the spraying step, and the film-forming step, the temperature of the interior of the powder passage and the temperature of the rotary stirring section are each regulated to a predetermined temperature.

Such a method for manufacturing a toner can be implemented with use of a rotary stirring device composed of a circulation section, a temperature regulation jacket, and a spraying section. The circulation section effects repeated circulation of the toner base particles and the fine resin particles within a powder passage including a rotary stirring chamber and a circulating tube and return of those particles to the rotary stirring chamber by means of a rotary stirring section including a rotary disc with rotating vanes installed therearound, and a rotary shaft. The temperature regulation jacket is disposed in at least a part of the exterior of the powder passage and the rotary stirring section, for regulating the temperature of the interior of the powder passage to a predetermined temperature.

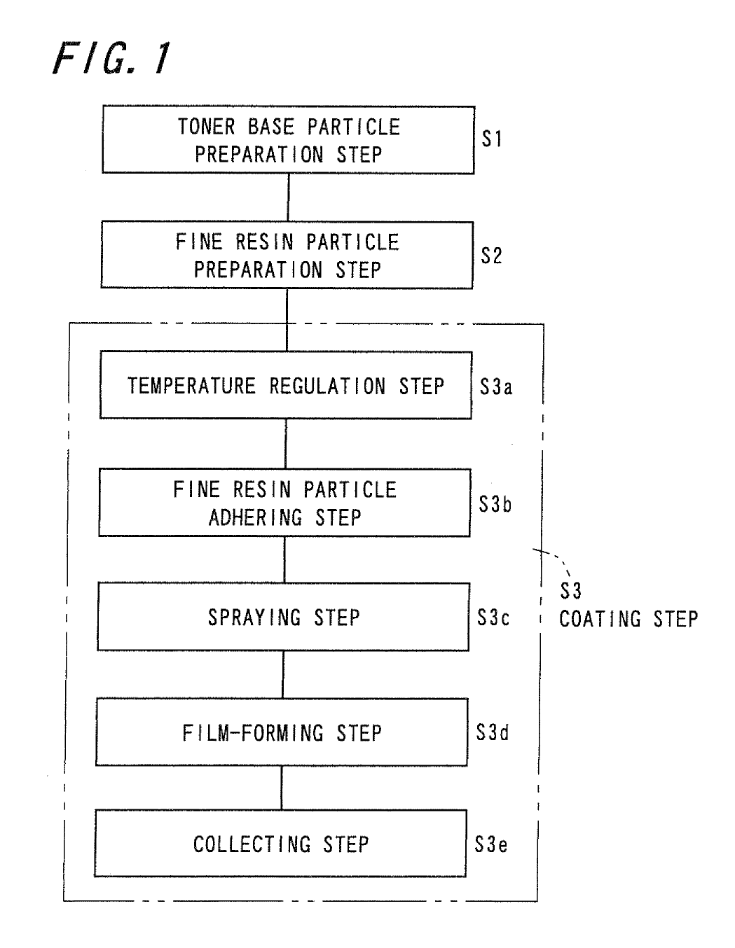

FIG. 1 is a flowchart of an example of a procedure for the method for manufacturing a toner according to this embodiment. As shown in FIG. 1, the method for manufacturing a toner of this embodiment includes a toner base particle preparation step S1 of producing toner base particles, a fine resin particle preparation step S2 of preparing fine resin particles, and a coating step S3 of coating the toner base particles with the fine resin particles.

(1) Toner Base Particle Preparation Step

At the toner base particle preparation step of step S1, toner base particles to be coated with a resin layer are prepared. The toner base particles are particles containing a binder resin and a colorant and are able to be obtained with a known method without particular limitation to a production method thereof. Examples of the method for producing toner base particles include dry methods such as pulverization methods, and wet methods such as suspension polymerization methods, emulsion aggregation methods, dispersion polymerization methods, dissolution suspension methods and melting emulsion methods. The method for producing toner base particles using a pulverization method will be described below.

(Method for Preparing Toner Base Particles by a Pulverization Method)

In a method for preparing toner base particles using a pulverization method, a toner composition containing a binder resin, a colorant and other additives is dry-mixed by a mixer, and thereafter melt-kneaded by a kneading machine. The kneaded material obtained by melt-kneading is cooled and solidified, and then the solidified material is pulverized by a pulverizing machine. Subsequently, the toner base particles are optionally obtained by conducting adjustment of a particle size such as classification.

Usable mixers include heretofore known mixers including, for example, Henschel-type mixing devices such as HENSCHELMIXER (trade name) manufactured by Mitsui Mining Co., Ltd., SUPERMIXER (trade name) manufactured by Kawata MEG Co., Ltd., and MECHANOMILL (trade name) manufactured by Okada Seiko Co., Ltd., ANGMILL (trade name) manufactured by Hosokawa Micron Corporation, HYBRIDIZATION SYSTEM (trade name) manufactured by Nara Machinery Co., Ltd., and COSMOSYSTEM (trade name) manufactured by Kawasaki Heavy Industries, Ltd.

Usable kneaders include heretofore known kneaders including, for example, commonly-used kneaders such as a twin-screw extruder, a three roll mill, and a laboplast mill. Specific examples of such kneaders include single or twin screw extruders such as TEM-100B (trade name) manufactured by Toshiba Machine Co., Ltd., PCM-65/87 and PCM-30, both of which are trade names and manufactured by Ikegai, Ltd., and open roll-type kneading machines such as KNEADEX (trade name) manufactured by Mitsui Mining Co., Ltd. Among them, the open roll-type kneading machines are preferable.

Examples of the pulverizing machine include a jet pulverizing machine that performs pulverization using ultrasonic jet air stream, and an impact pulverizing machine that performs pulverization by guiding a solidified material to a space formed between a rotor that is rotated at high speed and a stator (liner).

For the classification, a known classifying machine capable of removing excessively pulverized toner base particles by classification with a centrifugal force or classification with a wind force is usable and an example thereof includes a revolving type wind-force classifying machine (rotary type wind-force classifying machine).

(Raw Materials of Toner Base Particles)

As described above, the toner base particles contain the binder resin and the colorant. The binder resin is not particularly limited and any known binder resin used for a black toner or a color toner is usable, and examples thereof include a styrene resin such as a polystyrene and a styrene-acrylic acid ester copolymer resin, an acrylic resin such as a polymethylmethacrylate, a polyolefin resin such as a polyethylene, a polyester, a polyurethane, and an epoxy resin. Further, a resin obtained by polymerization reaction induced by mixing a monomer mixture material and a release agent may be used. The binder resin may be used each alone, or two or more of them may be used in combination.

Among the binder resins, polyester is preferable as binder resin for color toner owing to its excellent transparency as well as good powder flowability, low-temperature fixing property, and secondary color reproducibility. For polyester, heretofore known substances may be used including a polycondensation of polybasic acid and polyvalent alcohol.

For polybasic acid, substances known as monomers for polyester can be used including, for example: aromatic carboxylic acids such as terephthalic acid, isophthalic acid, phthalic anhydride, trimellitic anhydride, pyromellitic acid, and naphthalene dicarboxylic acid; aliphatic carboxylic acids such as maleic anhydride, fumaric acid, succinic acid, alkenyl succinic anhydride, and adipic acid; and methyl-esterified compounds of these polybasic acids. The polybasic acids may be used each alone, or two or more of them may be used in combination.

For polyvalent alcohol, substances known as monomers for polyester can also be used including, for example: aliphatic polyvalent alcohols such as ethylene glycol, propylene glycol, butenediol, hexanediol, neopentyl glycol, and glycerin; alicyclic polyvalent alcohols such as cyclohexanediol, cyclohexanedimethanol, and hydrogenated bisphenol A; and aromatic diols such as ethylene oxide adduct of bisphenol A and propylene oxide adduct of bisphenol A. The polyvalent alcohols may be used each alone, or two or more of them may be used in combination.

The polybasic acid and the polyvalent alcohol can undergo polycondensation reaction in an ordinary manner, that is, for example, the polybasic acid and the polyvalent alcohol are brought into contact with each other in the presence or absence of the organic solvent and in the presence of the polycondensation catalyst. The polycondensation reaction ends when an acid number, a softening temperature, etc. of the polyester to be produced reach predetermined values. The polyester is thus obtained. When the methyl-esterified compound of the polybasic acid is used as part of the polybasic acid, demethanol polycondensation reaction is caused. In the polycondensation reaction, a compounding ratio, a reaction rate, etc. of the polybasic acid and the polyvalent alcohol are appropriately modified, thereby being capable of, for example, adjusting a content of a carboxyl end group in the polyester and thus allowing for denaturation of the polyester. The denatured polyester can be obtained also by simply introducing a carboxyl group to a main chain of the polyester with use of trimellitic anhydride as polybasic acid. Note that polyester self-dispersible in water may also be used which polyester has a main chain or side chain bonded to a hydrophilic radical such as a carboxyl group or a sulfonate group. Further, polyester may be grafted with acrylic resin.

It is preferred that the binder resin have a glass transition temperature of 30° C. or higher and 80° C. or lower. The binder resin having a glass transition temperature lower than 30° C. easily causes the blocking that the toner thermally aggregates inside the image forming apparatus, which may decrease preservation stability. The binder resin having a glass transition temperature higher than 80° C. lowers the fixing property of the toner onto a recording medium, which may cause a fixing failure.

As the colorant, it is possible to use an organic dye, an organic pigment, an inorganic dye, an inorganic pigment or the like which is customarily used in the electrophotographic field.

Examples of black colorant include carbon black, copper oxide, manganese dioxide, aniline black, activated carbon, non-magnetic ferrite, magnetic ferrite, and magnetite.

Examples of yellow colorant include chrome yellow, zinc yellow, cadmium yellow, yellow iron oxide, mineral fast yellow, nickel titanium yellow, navel yellow, naphthol yellow S, hanza yellow G, hanza yellow 100, benzidine yellow G, benzidine yellow GR, quinoline yellow lake, permanent yellow NCG, tartrazine lake, C.I. pigment yellow 12, C.I. pigment yellow 13, C.I. pigment yellow 14, C.I. pigment yellow 15, C.I. pigment yellow 17, C.I. pigment yellow 93, C.I. pigment yellow 94, C.I. pigment yellow 138, C.I. pigment yellow 180, and C.I. pigment yellow 185.

Examples of orange colorant include red chrome yellow, molybdenum orange, permanent orange GTR, pyrazolone orange, vulcan orange, indanthrene brilliant orange RK, benzidine orange G, indanthrene brilliant orange GK, C.I. pigment orange 31, and C.I. pigment orange 43.

Examples of red colorant include red iron oxide, cadmium red, red lead oxide, mercury sulfide, cadmium, permanent red 4R, lysol red, pyrazolone red, watching red, calcium salt, lake red C, lake red D, brilliant carmine 6B, eosin lake, rhodamine lake B, alizarin lake, brilliant carmine 3B, C.I. pigment red 2, C.I. pigment red 3, C.I. pigment red 5, C.I. pigment red 6, C.I. pigment red 7, C.I. pigment red 15, C.I. pigment red 16, C.I. pigment red 48:1, C.I. pigment red 53: 1, C.I. pigment red 57:1, C.I. pigment red 122, C.I. pigment red 123, C.I. pigment red 139, C.I. pigment red 144, C.I. pigment red 149, C.I. pigment red 166, C.I. pigment red 177, C.I. pigment red 178, and C.I. pigment red 222.

Examples of purple colorant include manganese purple, fast violet B, and methyl violet lake.

Examples of blue colorant include Prussian blue, cobalt blue, alkali blue lake, Victoria blue lake, phthalocyanine blue, non-metal phthalocyanine blue, phthalocyanine blue-partial chlorination product, fast sky blue, indanthrene blue BC, C.I. pigment blue 15, C.I. pigment blue 15:2, C.I. pigment blue 15:3, C.I. pigment blue 16, and C.I. pigment blue 60.

Examples of green colorant include chromium green, chromium oxide, pigment green B, malachite green lake, final yellow green G, and C.I. pigment green 7.

Examples of white colorant include those compounds such as zinc oxide, titanium oxide, antimony white, and zinc sulfide.

The colorants may be used each alone, or two or more of the colorants of different colors may be used in combination. Further, two or more of the colorants with the same color may be used in combination. A usage of the colorant is not limited to a particular amount, and preferably 5 parts by weight to 20 parts by weight, and more preferably 5 parts by weight to 10 parts by weight based on 100 parts by weight of the binder resin.

The colorant may be used as a masterbatch to be dispersed uniformly in the binder resin. Further, two or more kinds of the colorants may be formed into a composite particle. The composite particle is capable of being manufactured, for example, by adding an appropriate amount of water, lower alcohol and the like to two or more kinds of colorants and granulating the mixture by a general granulating machine such as a high-speed mill, followed by drying. The masterbatch and the composite particle are mixed into the toner composition at the time of dry-mixing.

The toner base particles may contain a charge control agent in addition to the binder resin and the colorant. For the charge control agent, charge control agents commonly used in this field for controlling a positive charge and a negative charge are usable.

Examples of the charge control agent for controlling a positive charge include a basic dye, a quaternary ammonium salt, a quaternary phosphonium salt, an aminopyrine, a pyrimidine compound, a polynuclear polyamino compound, an aminosilane, a nigrosine dye, a derivative thereof, a triphenylmethane derivative, a guanidine salt and an amidin salt.

Examples of the charge control agent for controlling a negative charge include an oil-soluble dye such as an oil black and a spirone black, a metal-containing azo compound, an azo complex dye, a naphthene acid metal salt, a metal complex or metal salt (the metal is a chrome, a zinc, a zirconium or the like) of a salicylic acid or of a derivative thereof, a boron compound, a fatty acid soap, a long-chain alkylcarboxylic acid salt and a resin acid soap. The charge control agents may be used each alone, or optionally two or more of them may be used in combination. Although the amount of the charge control agent to be used is not particularly limited and can be properly selected from a wide range, 0.5 parts by weight or more and 3 parts by weight or less is preferably used relative to 100 parts by weight of the binder resin.

Further, the toner base particles may contain a release agent in addition to the binder resin and the colorant. As the release agent, it is possible to use ingredients which are customarily used in the relevant field, including, for example, petroleum wax such as paraffin wax and derivatives thereof, and microcrystalline wax and derivatives thereof; hydrocarbon-based synthetic wax such as Fischer-Tropsch wax and derivatives thereof, polyolefin wax (e.g. polyethylene wax and polypropylene wax) and derivatives thereof, low-molecular-weight polypropylene wax and derivatives thereof, and polyolefinic polymer wax (low-molecular-weight polyethylene wax, etc.) and derivatives thereof; vegetable wax such as carnauba wax and derivatives thereof, rice wax and derivatives thereof, candelilla wax and derivatives thereof, and haze wax; animal wax such as bees wax and spermaceti wax; fat and oil-based synthetic wax such as fatty acid amides and phenolic fatty acid esters; long-chain carboxylic acids and derivatives thereof; long-chain alcohols and derivatives thereof; silicone polymers; and higher fatty acids. Note that examples of the derivatives include oxides, block copolymers of a vinylic monomer and wax, and graft-modified derivatives of a vinylic monomer and wax. A usage of the wax may be appropriately selected from a wide range without particularly limitation, and preferably 0.2 part by weight to 20 parts by weight, more preferably 0.5 part by weight to 10 parts by weight, and particularly preferably 1.0 part by weight to 8.0 parts by weight based on 100 parts by weight of the binder resin.

The toner base particles obtained at the toner base particle preparation step S1 preferably have a volume average particle size of 4 μm or more and 8 μm or less. In a case where the volume average particle size of the toner base particles is 4 μm or more and 8 μm or less, it is possible to stably form a high-definition image for a long time. Moreover, by reducing the particle size to this range, a high image density is obtained even with a small amount of adhesion, which generates an effect capable of reducing an amount of toner consumption. In a case where the volume average particle size of the toner base particles is less than 4 μm, the particle size of the toner base particles becomes too small and high charging and low fluidity are likely to occur. When the high charging and the low fluidity occur, a toner is unable to be stably supplied to a photoreceptor and a background fog and image density decrease are likely to occur. In a case where the volume average particle size of the toner base particles exceeds 8 μm, the particle size of the toner base particles becomes large and the layer thickness of a formed image is increased so that an image with remarkable granularity is generated and the high-definition image is not obtainable, which is undesirable. In addition, as the particle size of the toner base particles is increased, a specific surface area is reduced, resulting in decrease in a charge amount of the toner. When the charge amount of the toner is reduced, the toner is not stably supplied to the photoreceptor and pollution inside the apparatus due to toner scattering is likely to occur.

(2) Fine Resin Particle Preparation Step

At the fine resin particle preparation step of step S2, dried fine resin particles are prepared. Any method may be used for the drying method and it is possible to obtain the dried fine resin particles by using methods such as drying of a hot air receiving type, drying of heat transfer by heat conduction type, far infrared radiation drying, and microwave drying. The fine resin particles are used as a material for forming a film on the toner base particles at the subsequent coating step S3. By using the fine resin particles as the film-forming material on the surface of the toner base particles, for example, it is possible to prevent generation of aggregation due to melting of low-melting point components such as a release agent contained in the toner base particles during storage. Further, in a case where the substance in liquid form in which the fine resin particles are dispersed is sprayed to coat the toner base particles, the shape of the fine resin particles remain on the surface of the toner base particles, and therefore, it is possible to obtain a toner excellent in a cleaning property compared to a toner with a flat surface.

The fine resin particles as described above can be obtained, for example, in a manner that raw materials of the fine resin particles are emulsified and dispersed into fine grains by using a homogenizer or the like machine. Further, the fine resin particles can also be obtained by polymerizing monomers.

For the resin used for raw materials of the fine resin particles, a resin used for materials of a toner is usable and examples thereof include a polyester, an acrylic resin, a styrene resin, and a styrene-acrylic copolymer. Among the resins exemplified above, the fine resin particles preferably contain an acrylic resin and a styrene-acrylic copolymer. The acrylic resin and the styrene-acrylic copolymer have many advantages such that the strength is high with light weight, transparency is high, the price is low, and materials having a uniform particle size are easily obtained.

Although the resin used for raw materials of the fine resin particles may be the same kind of resin as the binder resin contained in the toner base particles or may be a different kind of resin, the different kind of resin is preferably used in view of performing the surface modification of the toner. When the different kind of resin is used as the resin used for the raw materials of the fine resin particles, a softening temperature of the resin used for the raw materials of the fine resin particles is preferably higher than a softening temperature of the binder resin contained in the toner base particles. This makes it possible to prevent toners manufactured with the manufacturing method of this embodiment from being fused each other during storage and to improve storage stability. Further, the softening temperature of the resin used for the raw materials of the fine resin particles depends on an image forming apparatus in which the toner is used, but is preferably 80° C. or higher and 140° C. or lower. By using the resin in such a temperature range, it is possible to obtain the toner having both the storage stability and the fixing performance.

The volume average particle size of the fine resin particles needs to be sufficiently smaller than the average particle size of the toner base particles, and is preferably 0.05 μm or more and 1 μm or less. More preferably, the volume average particle size of the fine resin particles is 0.1 μm or more and 0.5 μm or less. In a case where the volume average particle size of the fine resin particles is 0.05 μm or more and 1 μm or less, a projection with a suitable size is formed on the surface of the coating layer. Whereby, the toner manufactured with the manufacturing method of this embodiment is easily caught by cleaning blades at the time of cleaning, resulting in improvement of the cleaning property.

(3) Coating Step

### <Toner Manufacturing Apparatus>

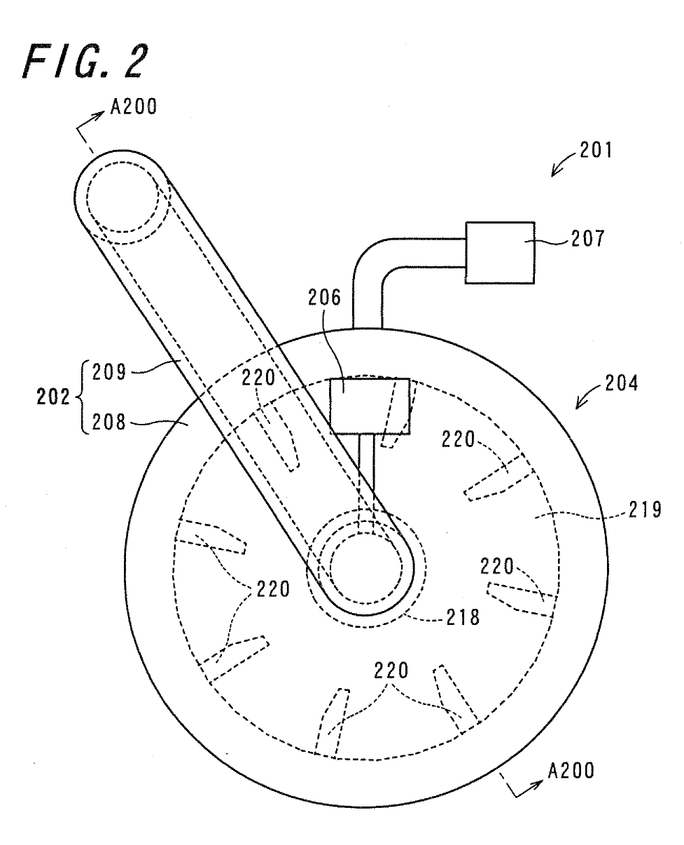

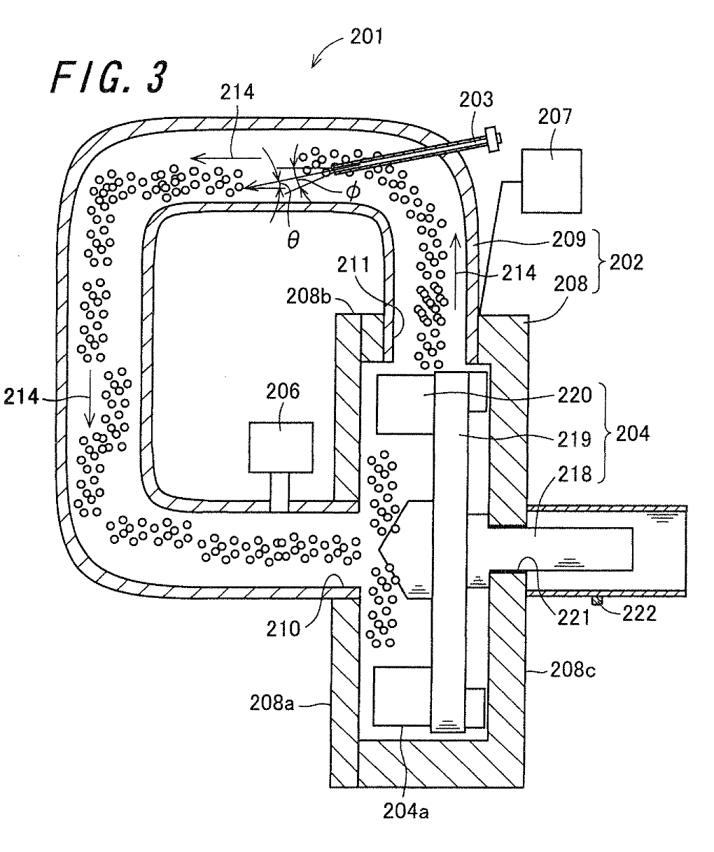

FIG. 2 is a front view of a configuration of a toner manufacturing apparatus 201 used for the method for manufacturing a toner which is a first embodiment of the invention. FIG. 3 is a schematic sectional view of the toner manufacturing apparatus 201 shown in FIG. 2 taken along the cross-sectional line A200-A200. At the coating step of step S3, for example, using the toner manufacturing apparatus 201 shown in FIG. 2, the fine resin particles prepared at the fine resin particle preparation step of step S2 are adhered to the toner base particles prepared at the toner base particle preparation step of step S1 to form a resin film on the toner base particles by a multiplier effect of circulation and an impact force of stirring in the apparatus. The toner manufacturing apparatus 201 which is a rotary stirring apparatus comprises a powder passage 202, a spraying section 203, a rotary stirring section 204, a temperature regulation jacket (not shown), a powder inputting section 206, and a powder collecting section 207. The rotary stirring section 204 and the powder passage 202 constitute a circulation section.

(Powder Passage)

The powder passage 202 is comprised of a stirring section 208 and a powder flowing section 209. The stirring section 208 is a cylindrical container-like member having an internal space. Opening sections 210 and 211 are formed in the stirring section 208 which is a rotary stirring chamber. The opening section 210 is formed at an approximate center part of a surface 208a in one side of the axial direction of the stirring section 208 so as to penetrate a side wall including the surface 208a of the stirring section 208 in the thickness direction. Moreover, the opening section 211 is formed at a side surface 208b perpendicular to the surface 208a in one side of the axial direction of the stirring section 208 so as to penetrate a side wall including the side surface 208b of the stirring section 208 in the thickness direction. The powder flowing section 209 which is a circulating tube has one end connected to the opening section 210 and the other end connected to the opening section 211. Whereby, the internal space of the stirring section 208 and the internal space of the powder flowing section 209 are communicated to form the powder passage 202. The toner base particles, the fine resin particles and gas flow through the powder passage 202. The powder passage 202 is provided so that the powder flowing direction which is a direction in which the toner base particles and the fine resin particles flow is constant.

(Rotary Stirring Section)

The rotary stirring section 204 includes a rotary shaft member 218, a rotary disc 219, and a plurality of stirring blades 220. The rotary shaft member 218 is a cylindrical-bar-shaped member that has an axis matching an axis of the stirring section 208, that is provided so as to be inserted in a through-hole 221 formed at the surface 208c in the other side of the axial direction of the stirring section 208 to penetrate the side wall including the surface 208c in the thickness direction, and that is rotated around the axis by a motor (not shown). The rotary disc 219 is a discotic member having the axis supported by the rotary shaft member 218 so as to match the axis of the rotary shaft member 218 and rotating with rotation of the rotary shaft member 218. The plurality of stirring blades 220 are supported by the peripheral edge of the rotary disc 219 and are rotated with rotation of the rotary disc 219.

The rotary shaft member 218 is rotatable at peripheral speed of 50 m/sec or more in an outermost peripheral. The outermost peripheral is a part of the rotary stirring section 204 that has the longest distance from the rotary shaft member 218 in the direction perpendicular to the rotary shaft member 218.

(Spraying Section)

In the powder flowing section 209 of the powder passage 202, the spraying section 203 is provided in the powder flowing section that is on the side closest to the opening section 211 in the flowing direction of the toner base particles and the fine resin particles. The spraying section 203 includes a liquid reservoir that reserves a substance in a form of liquid, a carrier gas supplying section that supplies carrier gas, and a two-fluid nozzle that mixes the substance in the form of liquid and the carrier gas, ejects the obtained mixture to the toner base particles present in the powder passage 202, and sprays droplets of the substance in the form of liquid to the toner base particles. For the carrier gas, compressed air or the like is usable.

(Temperature Regulation Jacket)

The non-illustrated temperature regulation jacket (not shown) acting as the temperature regulation section is disposed in at least a part of the exterior of the powder passage 202. By admitting a cooling medium or a heating medium into the inner space of the jacket, it is possible to regulate each of the temperature of the interior of the powder passage 202 and the temperature of the rotary stirring section 204 to a predetermined temperature. In the present embodiment, it is preferable that the temperature regulation jacket is disposed over the entire exterior of the powder passage 202. This makes it possible to suppress adhesion of the toner base particles and the fine resin particles to the inner wall of the powder passage 202 resulting from an excessive temperature rise. Accordingly, the interior of the powder passage 202 can be prevented from narrowing due to the adhesion of the toner base particles and the fine resin particles, wherefore a toner that is composed of the toner base particles whose surfaces are uniformly coated with a film of the fine resin particles and is thus excellent in cleanability can be manufactured in a high yield. Moreover, since each of the temperature of the interior of the powder passage 202 and the temperature of the rotary stirring section 204 can be regulated to the predetermined temperature, it follows that the adhesion and filmization of the fine resin particles on the toner base particles proceed smoothly, with the result that the adherability of adherents to the inner wall of the powder passage 202 is decreased even further. This makes it possible to lessen the degree of adhesion of the toner base particles and the fine resin particles to the inner wall of the powder passage even further, and thereby prevent the interior of the powder passage from narrowing due to the adhesion of the toner base particles and the fine resin particles more securely.

(Powder Inputting Section and Powder Collecting Section)

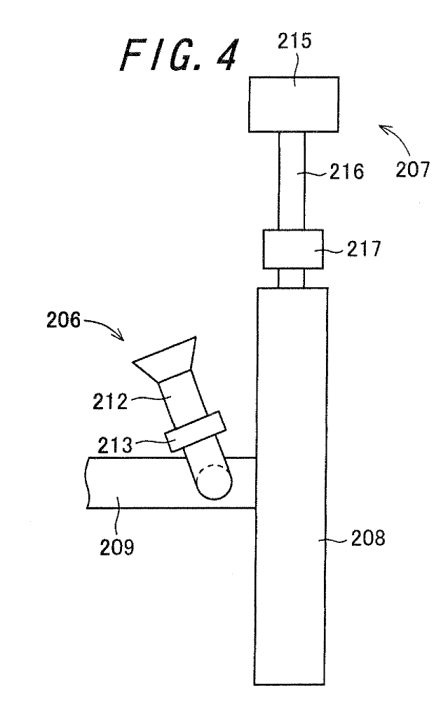

The powder flowing section 209 of the powder passage 202 is connected to the powder inputting section 206 and the powder collecting section 207. FIG. 4 is a front view of a configuration around the powder inputting section 206 and the powder collecting section 207. The powder inputting section 206 includes a hopper (not shown) that supplies the toner base particles and the fine resin particles, a supplying tube 212 that communicates the hopper and the powder passage 202, and an electromagnetic valve 213 provided in the supplying tube 212. The toner base particles and the fine resin particles supplied from the hopper are supplied to the powder passage 202 through the supplying tube 212 in a state where the passage in the supplying tube 212 is opened by the electromagnetic valve 213. The toner base particles and the fine resin particles supplied to the powder passage 202 flow in the constant powder flowing direction with stirring by the rotary stirring section 204. Moreover, the toner base particles and the fine resin particles are not supplied to the powder passage 202 in a state where the passage in the supplying tube 212 is closed by the electromagnetic valve 213.

The powder collecting section 207 includes a collecting tank 215, a collecting tube 216 that communicates the collecting tank 215 and the powder passage 202, and an electromagnetic valve 217 provided in the collecting tube 216. The toner particles flowing through the powder passage 202 are collected in the collecting tank 215 through the collecting tube 216 in a state where the passage in the collecting tube 216 is opened by the electromagnetic valve 217. Moreover, the toner particles flowing through the powder passage 202 are not collected in a state where the passage in the collecting tube 216 is closed by the electromagnetic valve 217.

The coating step S3 using the toner manufacturing apparatus 1 as described above includes a temperature regulation step S3a, a fine resin particle adhering step S1b, a spraying step S3c, a film-forming step S3d, and a collecting step S3e.

(3)-1 Temperature Regulation Step S3a

At the temperature regulation step of step S3a, while the rotary stirring section 204 is rotated, temperatures in the powder passage 202 and of the rotary stirring section 204 are regulated to a predetermined temperature by passing a medium through the temperature regulation jacket disposed on the outside thereof. This makes it possible to control the temperature in the powder passage 202 at a temperature or less at which the toner base particles and the fine resin particles that are inputted at the fine resin particle adhering step S3b described below are not softened and deformed.

(3)-2 Fine Resin Particle Adhering Step S3b

At the fine resin particle adhering step of step S3b, the toner base particles and the fine resin particles are supplied from the powder inputting section 206 to the powder passage 202 in a state where the rotary shaft member 218 of the rotary stirring section 204 is rotated. The toner base particles and the fine resin particles supplied to the powder passage 202 are stirred by the rotary stirring section 204 to flow through the powder flowing section 209 of the powder passage 202 in the direction indicated by an arrow 214. Whereby, the fine resin particles are adhered to the surface of the toner base particles. At this time, by using toner base particles obtained by performing the unprocessed base particle surface treatment processing step S1b as the toner base particles, it is possible to adhere the fine resin particles uniformly to the surface of the toner base particles.

(3)-3 Spraying Step S3c

At the spraying step of step S3c, the toner base particles and the fine resin particles in a fluidized state in the powder passage 202 are sprayed with a substance in liquid form having an effect of plasticizing the particles without dissolving from the spraying section 203 by carrier gas. The spraying section 203 is a two-fluid nozzle. The substance in liquid form is fed to the spraying section 203 by a liquid feeding pump with a constant flow amount and the substance in liquid form sprayed by the spraying section 203 is gasified so that the gasified substance is spread on the surface of the toner base particles and the fine resin particles. Whereby, the toner base particles and the fine resin particles are plasticized.

In this embodiment, it is preferable that the substance in the form of liquid is started to be sprayed from the spraying section 203 after the flow rate of the toner base particles and the fine resin particles is stabilized in the powder passage 202. Whereby, it is possible to spray the substance in the form of liquid to the toner base particles and the fine resin particles uniformly, thus making it possible to improve yield of the toner uniformly coated with the coating layer.

(Spray Liquid)

Although there is no particular limitation to the substance in liquid form having the effect of plasticizing the toner base particles and the fine resin particles without causing their dissolution, since the substance in liquid form needs to be removed from the toner base particles and the fine resin particles following the completion of spray treatment, it is desirable to use a substance in liquid form which is easy to evaporate. In general, substances in liquid form that satisfy such a requirement have a low boiling point and are readily vaporized. Therefore, under normal circumstances, an organic solvent which can be gasified quite rapidly is selected for use. As is generally true of techniques for the gasified substance control, there is known “Explosive limit concentration”. The explosive limit concentration indicates a range of concentrations that induce explosion in a gas of the air-gasified substance mixture, and the lowest concentration level is referred to as “LEL (Lower Explosive Limit) concentration”.

In the invention, this LEL concentration is deemed to be a characteristic specific to the gasified substance in terms of a volumetric concentration. While, in general, the LEL concentration indicates an explosion-inducible concentration range for a gas of the gasified substance-air mixture, in the invention, the LEL concentration is used as a value indicative of a limit volumetric concentration specific to a gasified liquid. Even if a non-explosive gas such as nitrogen is contained in the gas mixture, similarly, the LEL concentration is deemed to be a characteristic specific to a gasified liquid.

Now, how the LEL concentration is to be measured will be described. LEL concentration measurement can be carried out by using a method established by Technology Institution of Industrial Safety, for example. Moreover, LEL concentration measurement can alternatively be carried out by conducting experiments with reference to Safety Data published by National Institute of Industrial Safety (RIIS-SD-86, 1986), for example.

The range of concentrations that induce explosion in a gas of the gasified substance-air mixture, i.e. the explosive limit concentration range varies depending on pressure and temperature. In general, the higher is the temperature or the higher is the pressure, the wider is the explosive limit concentration range. In the invention, the lower explosive limit concentration as observed under conditions of a pressure of 1 atmospheric pressure, a temperature of a room temperature (25° C.), and an oxygen partial pressure of 20% is defined as the LEL concentration specific to the gasified substance.

Moreover, in a case where the substance in liquid form to be sprayed into the powder passage 202 is composed of a mixture of two or more kinds of liquids, in accordance with the following formula (2) based on Le Chatelier's law, the LEL concentration is derived by calculation.

V=100/(N₁/V₁+N₂/V₂ . . . +Nᵢ/Vᵢ +. . . ) (2)

wherein

V represents the LEL concentration (% by volume) of the gasified liquid mixture;

Vᵢ represents the lower explosive limit concentration (% by volume) of i component contained in the liquid mixture; and

Nᵢ represents the volumetric proportion (% by volume) of i component contained in a gas mixture resulting from gasification of the liquid mixture.

For example, in the case of using a liquid of a mixture of ethanol having an LEL concentration of 3.3% by volume and methanol having an LEL concentration of 6.7% by volume, let it be assumed that the volumetric proportion of the ethanol in a gasified state is 70% by volume and the volumetric proportion of the methanol in a gasified state is 30% by volume. In this case, on the basis of the formula (2), the LEL concentration V of the gasified liquid mixture is representable in expression form as: V=100/{(70/3.3)+(30/6.7)}=3.9% by volume.

In regard to the substance in liquid form which is sprayed from the spraying section 203 in the spraying step S3c, in the case of using a liquid mixture therefor, it is preferable that the liquid mixture is controlled in liquid-mixture LEL concentration within a range of from 1.4% to 6.7% by volume. On the other hand, in the case of using a single substance in liquid form, an alcohol which ranges in single-liquid LEL concentration from 1.4% to 6.7% by volume is suited for use. If an alcohol whose LEL concentration is lower than 1.4% by volume is used, since such an alcohol is unable to evaporate quickly, it follows that the toner base particles and the fine resin particles are inconveniently dried slowly even after their plasticization, in consequence whereof there result mutual tight adhesion and aggregation among the toner base particles or the fine resin particles. This leads to undesirable deformation and mutual aggregation of toner particles, which renders it impossible to obtain a toner having desired particle shape and size in a high yield. By contrast, if an alcohol whose LEL concentration is higher than 6.7% by volume is used, the ability of the alcohol to plasticize the toner base particles and the fine resin particles is so poor that the fine resin particles are unable to change to a film state on the surfaces of the toner base particles at a desired pace. As a result, the filmization of the fine resin particles ends in failure, or too long a time needs to be spent in the filmization, which renders it impossible to obtain a toner having the desired particle size in a high yield. For the reasons thus far described, there is a need to control the amount of liquid to be used within the apparatus in conformity with the LEL concentration of the substance in liquid form for use. More specifically, a substance in liquid form of low LEL concentration needs to be used in relatively low concentrations, whereas a substance in liquid form of high LEL concentration needs to be used in relatively high concentrations. In order to strike a proper balance, LEL concentration coefficients can be adopted. In this case, liquid control can be carried out adequately without reference to the LEL concentration of the substance in liquid form for use.

The examples of alcohols having an LEL concentration in a range of from 1.4% to 6.7% by volume include low-grade alcohols such as methanol, ethanol, propanol, and butanol. Moreover, among those low-grade alcohols, an alcohol in which a number of carbon in a molecule is of 3 or below is particularly desirable. The use of such an alcohol makes it possible to enhance the wettability of the fine resin particles provided as a coating material with respect to the surfaces of the toner base particles, to allow the fine resin particles to adhere to the entire or most part of the surfaces of the toner base particles, and to facilitate the change in shape and filmization of the fine resin particles. As another advantage, since such a low-grade alcohol has a high vapor pressure, its use makes it possible to shorten the time of drying required for substance-in-liquid-form removal, and thereby suppress mutual aggregation among the toner base particles.

In addition, such a low-grade alcohol has a low viscosity and is thus easy to evaporate. Therefore, in a case where a low-grade alcohol is contained in the substance in liquid form, it never occurs that the substance in liquid form in the form of large-diameter droplets squirts from the spraying section 203. This makes it possible to give a squirt of minute-diameter fine droplets of the substance in liquid form, as well as to render the diameters of the droplets of substance in liquid form uniform. Moreover, upon collision with the toner base particles, the liquid droplets become finer, whereby the surfaces of the toner base particles and the fine resin particles can be wetted uniformly and lubricated. Application of the fine liquid droplets in synergy with the collision energy helps soften the fine resin particles. As a result, there is obtained a toner having a coating layer which is excellent in uniformity. Note that the viscosity of the substance in liquid form is measured at 25° C. For example, measurement of viscosity of substance in liquid form can be carried out by means of a cone-plate rotational viscometer.

(LEL Concentration Coefficient X Within Powder Passage 202)

In the spraying step S3c, the substance in liquid form is sprayed from the spraying section 203 in such a manner that the LEL concentration coefficient X within the powder passage 202 satisfies the following formula (1).

0.07≦X≦8.12 (1)

The LEL concentration coefficient X within the powder passage 202 is determined by calculation as follows.

At first, on the basis of the following formula (3), a gasification volume C of the substance in liquid form to be sprayed per unit of time is obtained.

Gasification volume C (L/min)={Liquid supply rate S (g/min)/Molecular weight of substance in liquid form}×22.4 (L) (3)

Then, on the basis of the following formula (4), the LEL concentration coefficient X within the powder passage 202 is obtained.

LEL concentration coefficient X={Gasification volume C (L/min)/Powder passage interior volume A (L)}100/LEL concentration of substance in liquid form (% by volume) (4)

Note that, in a case where the substance in liquid form which is sprayed from the spraying section 203 is of a liquid mixture, as the LEL concentration of substance in liquid form in the formula (4), the liquid-mixture LEL concentration V calculated on the basis of the formula (2) is adopted for use.

Thus, in the spraying step S3c, the substance in liquid form is sprayed in such a manner that the LEL concentration coefficient X within the powder passage 202 is greater than or equal to 0.07. In this way, the gas concentration of the substance gasified within the powder passage 202 stands at a level high enough to plasticize the toner base particles and the fine resin particles. Then, in the film-forming step S3d which will hereafter be described, the toner base particles and the fine resin particles are circulated repeatedly along with the substance having a gas concentration high enough to plasticize the toner base particles and the fine resin particles within the powder passage 202. This makes it possible to foster the filmization of the fine resin particles adherent to the toner base particles, and thereby produce a toner composed of the toner base particles whose surfaces are uniformly coated with a film of the fine resin particles.

Moreover, in the spraying step S3c, the substance in liquid form is sprayed in such a manner that the LEL concentration coefficient X within the powder passage 202 is smaller than or equal to 8.12. In this way, the substance in liquid form sprayed into the powder passage 202 can be prevented from remaining in the form of droplets in the system without undergoing gasification. This makes it possible to avoid development of aggregates resulting from adsorption of the liquid droplets on the toner base particles and the fine resin particles circulating within the powder passage 202, and thereby produce a toner composed of the toner base particles whose surfaces are uniformly coated with a film of the fine resin particles in a high yield.

(Discharge of the Gasified Substance Out of Powder Passage 202)

In such a manner that the LEL concentration coefficient X within the powder passage 202 falls within the foregoing range and also takes on a constant value, the substance being sprayed and gasified with a carrier gas (compressed air) is discharged, along with the air to be discharged, out of the powder passage 202 via the through hole 221. With the selection of a suitable substance in liquid form, the time of drying required to remove the substance in liquid form from the toner can be shortened, wherefore mutual aggregation among the toner base particles can be suppressed.

Moreover, in the toner manufacturing apparatus 201, compressed air is, on the one hand, used as a carrier gas for giving a spraying of substance in liquid form, and is, on the other hand, used also as protective air for providing protection for the bearings of the apparatus. Therefore, the rate of flow of air emission from the powder passage 202 interior is not equal to the rate of flow of the carrier gas supplied but is equal to the sum total of the flow rate of the carrier gas and the flow rate of the protective air. In the present embodiment, it is preferable that the flow rate of air emission from the powder passage 202 interior is adjusted to fall in a range of from 10 to 70 L/min. Note that the flow rate of air emission from the powder passage 202 interior varies according to the amount of supply of the carrier gas into the powder passage 202. If the air-emission flow rate is less than 10 L/min, the concentration of the gasified substance within the powder passage 202 is so high that the toner base particles and the fine resin particles are excessively plasticized, in consequence whereof there result mutual tight adhesion and aggregation among the toner base particles or the fine resin particles. This leads to a decline in the yields of the resin-coated toner. By contrast, if the air-emission flow rate is greater than 70 L/min, in addition to the carrier gas to be discharged, toner portions manufactured are inconveniently discharged out of the powder passage 202. This leads to a decline in the yields of the resin-coated toner.

Moreover, the gas discharge section, which serves as a path through which the gasified substance is discharged via the through hole 221 out of the powder passage 202, is formed with a concentration sensor 222 for detecting the concentration of the gasified substance. The concentration of the gasified substance which is measured by the concentration sensor 222 in the gas discharge section varies according to the LEL concentration coefficient X. With consideration given to the drying rate of the substance in liquid form, preventability of mutual aggregation among the toner base particles, and productivity, the concentration of the gasified liquid is adjusted to fall in a predetermined range. If the concentration of the gasified substance is unduly high, a sufficiently fast drying rate of substance in liquid form cannot be secured. In this case, undried toner base particles bearing the liquid droplets remaining on the surfaces thereof adhere to other toner base particles, in consequence whereof there result mutual aggregation among the toner base particles. By contrast, if the concentration of the gasified substance is unduly low, the productivity will be impaired.

An angle θ formed by the substance in the form of liquid spraying direction which is a direction of the axis of the two-fluid nozzle and the powder flowing direction which is a direction in which the toner base particles and the fine resin particles flow in the powder passage 202 is preferably 0° or more and 45° or less. In a case where the angle θ falls within this range, the droplet of the substance in liquid form is prevented from recoiling from the inner wall of the powder passage 202 and yield of the toner base particles coated with the resin film is able to be further improved. In a case where the angle θ formed by the substance in the form of liquid spraying direction from the spraying section 203 and the powder flowing direction exceeds 45°, the droplet of the substance in liquid form easily recoils from the inner wall of the powder passage 202 and the substance in liquid form is easily retained, thus generating aggregation of the toner particles and deteriorating the yield. The two-fluid nozzle is provided so as to be inserted in the opening formed on the outer wall of the powder passage 202.

Further, a spreading angle Φ of the substance in liquid form sprayed by the two-fluid nozzle is preferably 20° or more and 90° or less. In a case where the spreading angle Φ falls out of this range, it is likely be difficult to spray the substance in liquid form uniformly to the toner base particles.

(3)-4 Film-Forming Step

At the film-forming step of step S3d, with a multiplier effect of circulation by the toner manufacturing apparatus 201 and an impact force by stirring as well as thermal energy by stirring, the fine resin particles are softened to form a consecutive film and stirring of the rotary stirring section 204 is continued at a predetermined temperature to fluidize the toner base particles and the fine resin particles until the resin film is formed on the toner base particles.

(3)-5 Collecting Step

At the collecting step of step S3e, spraying of the substance in liquid form from the spraying section 203 is finished, rotation of the rotary stirring section 204 is stopped, the resin-coated toner is ejected outside the apparatus from the powder collecting section 207, and the resin-coated toner is collected.

In this way, the resin-coated toner is manufactured, but the peripheral speed of the outermost peripheral of the rotary stirring section 204 at the coating step S3 including steps S1a to S3e is preferably set to 30 m/sec or more, and more preferably to 50 m/sec or more. The outermost peripheral of the rotary stirring section 204 is a part 4a of the rotary stirring section 204 that has the longest distance from the axis of the rotary shaft member 218 in the direction perpendicular to the extending direction of the rotary shaft member 218 of the rotary stirring section 204. In a case where the peripheral speed in the outermost peripheral of the rotary stirring section 204 is at 30 m/sec or more at the time of rotation, it is possible to isolate and fluidize the toner base particles. In a case where the peripheral speed in the outermost peripheral is less than 30 m/sec, it is impossible to isolate and fluidize the toner base particles and the fine resin particles, thus making it impossible to uniformly coat the toner base particles with the resin film.

Further, at the coating step S3, the temperature regulation jacket is provided at least on a part of outside of the powder passage 202 and a temperature in the powder passage 202 is regulated to a predetermined temperature by passing a cooling medium or a heating medium through the internal space of the jacket. This makes it possible at the temperature regulation step S3a to control the temperature in the powder passage and outside of the rotary stirring section to a temperature or less at which the toner base particles and the fine resin particles that are inputted at the fine resin particle adhering step S1b are not softened and deformed. At the spraying step S3c and the film-forming step S3d, a variation in the temperature applied to the toner base particles, the fine resin particles and the substance in liquid form is reduced and it is possible to keep the stable fluidized state of the toner base particles and the fine resin particles.

Further, the toner base particles composed of a synthetic resin and the like and the fine resin particles generally collide with the inner wall of the powder passage many times, and a part of the collision energy is converted into the thermal energy at the time of collision and is accumulated in the toner base particles and the fine resin particles. As the number of the collision increases, the thermal energy accumulated in the particles increases and then the toner base particles and the fine resin particles are softened to be adhered to the inner wall of the powder passage, but by passing a cooling medium or a heating medium through the internal space of the jacket to regulate the temperature as described above, it is possible to suppress adhesion of the toner base particles and the fine resin particles to the inner wall of the powder passage 202 due to an excessive temperature rise and to suppress adhesion of the toner base particles and the fine resin particles to the inside of the powder passage 202 due to accumulation of the substance in the form of substance in liquid form sprayed from the spraying section 203 in the powder passage 202 and clogging in the powder passage 202. Accordingly, the toner base particles are coated with the fine resin particles uniformly, resulting that it is possible to manufacture a resin-coated toner excellent in a cleaning property in higher yield.

In the inside of the powder flowing section 209 downstream of the spraying section 203, the sprayed substance in liquid form is not dried and is retained, and the drying speed is made slow with an improper temperature and the substance in liquid form is easily retained, and when the toner base particles are in contact therewith, the toner base particles are easily adhered to the inner wall of the powder passage 202. This may be an aggregation generation source of the toner base particles. In the inner wall near the opening section 210, the toner base particles that flow in the powder flowing section 209 and flow into the stirring section 208 from the opening section 210 easily collide with the toner base particles that flow in the stirring section 208 with stirring of the rotary stirring section 204. Whereby, the collided toner base particles are easily adhered to the vicinity of the opening section 210. Accordingly, by providing the temperature regulation jacket in such a part where the toner base particles are easily adhered, it is possible to prevent the toner base particles from being adhered to the inner wall of the powder passage 202 more reliably.

The temperature in the powder passage 202 is set to a glass transition temperature of the toner base particles or lower. Further, the temperature in the powder passage 202 is more preferably 30° C. or higher and a glass transition temperature of the toner base particles or lower. The temperature in the powder passage 202 is almost uniform at any part in the powder passage 202 by the flow of the toner base particles. In a case where the temperature in the powder passage 202 exceeds the glass transition temperature of the toner base particles, there is a possibility that the toner base particles in the powder passage 202 are softened excessively and aggregation of the toner base particles is generated. Further, in a case where the temperature in the powder passage 202 is less than 30° C., there is a possibility that the drying speed of a dispersion liquid is made slow and the productivity is lowered. Accordingly, in order to prevent aggregation of the toner base particles, it is necessary that the temperature regulation jacket whose inner diameter is larger than an external diameter of the powder passage tube is disposed at least on a part of the outer side of the powder passage tube and the rotary stirring section 204 and an apparatus is provided that has a function of regulating the temperature by passing a cooling medium or a heating medium through the space thereof so as to maintain the temperature of the powder passage 202 and the rotary stirring section to the glass transition temperature of the toner base particles or less.

As described above, the rotary stirring section 204 includes the rotary disc 219 that is rotated with rotation of the rotary shaft member 218, and the toner base particles and the fine resin particles preferably collide with the rotary disc 219 vertically to the rotary disc 219, and more preferably collide with the rotary shaft member 218 vertically to the rotary disc 219. Whereby, it is possible to stir the toner base particles and the fine resin particles more sufficiently than the case where the toner base particles and the fine resin particles collide with the rotary disc 219 in parallel, thus making it possible to coat the toner base particles with the fine resin particles more uniformly and to further improve yield of the toner uniformly coated with the coating layer.

Moreover, the toner manufacturing apparatus 201 employed in the coating step S3 is not limited to the construction as suggested hereinabove, and therefore various modifications may be made therein. For example, the temperature regulation jacket may either be disposed over the entire exterior surfaces of the powder flowing section 209 and the stirring section 208 or disposed in a certain part of the exterior of the powder flowing section 209 or the stirring section 208. With the provision of the temperature regulation jacket over the entire exterior surfaces of the powder flowing section 209 and the stirring section 208, adhesion of the toner base particles to the inner wall of the powder passage 202 can be prevented more reliably.

Further, the toner manufacturing apparatus employed in the coating step S3 may be constructed of a combination of a commercially available stirrer and the spraying section. As a commercially available stirrer having a powder passage and a rotary stirring section, for example, Hybridization System (trade name) manufactured by Nara Machinery Co., Ltd. may be adopted for use. With the provision of a liquid spraying unit within such a stirrer, the stirrer may be employed as the toner manufacturing apparatus for use in the toner manufacturing method embodying the invention.

2. Toner

The toner according to the invention is manufactured by the method for manufacturing a toner of the invention thus far described. That is, the toner of the invention is a resin-coated toner composed of toner base particles having on their surfaces a resin coating layer made of fine resin particles in the form of a uniform film. Since the fine resin particles are changed to a uniform film state thereby to form the resin coating layer, it follows that the individual toner particles are uniform in toner characteristics such as a charging characteristic. Moreover, in the toner of the invention, the resin coating layer borne on the toner surface produces an inclusion-component protection effect. Accordingly, even if a material having a low melting point is used for the toner base particles, storage stability deterioration can be avoided. By performing image formation with use of such a toner, it is possible to form a good-quality image which exhibits high resolution and is free from unevenness in image density with stability.

Moreover, to the toner of the invention, an external additive may be added. As the external additive, heretofore known substances can be used including silica and titanium oxide. It is preferred that these substances be surface-treated with silicone resin and a silane coupling agent. A preferable usage of the external additive is 1 part by weight to 10 parts by weight based on 100 parts by weight of the toner.

3. Developer

The developer according to the invention contains the toner of the invention described hereinabove. Since the individual toner particles contained therein are uniform in toner characteristics such as a charging characteristic, it is possible to obtain a developer which is capable of sustaining satisfactory development performance. Moreover, in the developer of the invention, even if a material having a low melting point is used for the toner base particles, storage stability deterioration can be avoided. Accordingly, the developer, even when used in a high-temperature atmosphere, suffers little from flowability deterioration. It is thus possible to obtain a developer which is capable of sustaining satisfactory development performance.

Moreover, the developer of the invention may be used either as a one-component developer or a two-component developer. When the developer is used as a one-component developer, the toner is used alone without having to use a carrier. In addition, when the developer is used as a one-component developer, the toner is electrically charged by friction with a developing sleeve by means of a blade and a fur brush, so that it can be adhered onto the sleeve. In this way, the toner becomes conveyable so as to effect image formation. On the other hand, when the developer is used as a two-component developer, the toner of the invention is used in conjunction with a carrier. In this case, since the two-component developer contains the toner in which storage stability deterioration can be avoided even with use of a material having a low melting point for the toner base particles, it is possible to prevent deterioration in the charge imparting capability of the carrier resulting from occurrence of toner-spent on the carrier. It is thus possible to obtain a two-component developer which is capable of sustaining satisfactory development performance.

(Carrier)

As the carrier, heretofore known substances can be used including, for example, single or complex ferrite composed of iron, copper, zinc, nickel, cobalt, manganese, and chromium; a resin-coated carrier having carrier core particles whose surfaces are coated with coating substances; or a resin-dispersion carrier in which magnetic particles are dispersed in resin. As the coating substance, heretofore known substances can be used including polytetrafluoroethylene, a monochloro-trifluoroethylene polymer, polyvinylidene-fluoride, silicone resin, polyester, a metal compound of di-tertiary-butylsalicylic acid, styrene resin, acrylic resin, polyamide, polyvinyl butyral, nigrosine, aminoacrylate resin, basic dyes or lakes thereof, fine silica powder, and fine alumina powder. In addition, the resin used for the resin-dispersion carrier is not limited to particular resin, and examples thereof include styrene-acrylic resin, polyester resin, fluorine resin, and phenol resin. Both of the coating substance in the resin-coated carrier and the resin used for the resin-dispersion carrier are preferably selected according to the toner components. Those substances and resin listed above may be used each alone, and two or more thereof may be used in combination.

A particle of the carrier preferably has a spherical shape or flattened shape. A particle size of the carrier is not limited to a particular diameter, and in consideration of forming higher-quality images, the particle size of the carrier is preferably 10 μm to 100 μm and more preferably 20 μm to 50 μm. Further, the resistivity of the carrier is preferably 10⁸ Ω·cm or more, and more preferably 10¹² Ω·cm or more.

The resistivity of the carrier is obtained as follows. At the outset, the carrier is put in a container having a cross section of 0.50 cm², thereafter being tapped. Subsequently, a load of 1 kg/cm² is applied by use of a weight to the carrier particles which are held in the container as just stated. When an electric field of 1,000 V/cm is generated between the weight and a bottom electrode of the container by application of voltage, a current value is read. The current value indicates the resistivity of the carrier. When the resistivity of the carrier is low, electric charges will be injected into the carrier upon application of bias voltage to a developing sleeve, thus causing the carrier particles to be more easily attached to the photoreceptor. In this case, the breakdown of bias voltage is more liable to occur.

Magnetization intensity (maximum magnetization) of the carrier is preferably 10 emu/g to 60 emu/g and more preferably 15 emu/g to 40 emu/g. The magnetization intensity depends on magnetic flux density of a developing roller. Under the condition of ordinary magnetic flux density of the developing roller, however, no magnetic binding force work on the carrier having the magnetization intensity less than 10 emu/g, which may cause the carrier to spatter. The carrier having the magnetization intensity larger than 60 emu/g has bushes which are too large to keep the non-contact state with the image bearing member in the non-contact development or to possibly cause sweeping streaks to appear on a toner image in the contact development.

A use ratio of the toner to the carrier in the two-component developer is not limited to a particular ratio, and the use ratio is appropriately selected according to kinds of the toner and carrier. To take the resin-coated carrier (having density of 5 g/cm² to 8 g/cm²) as an example, the usage of the toner may be determined such that a content of the toner in the developer is 2% by weight to 30% by weight and preferably 2% by weight to 20% by weight of the total amount of the developer. Further, in the two-component developer, coverage of the carrier with the toner is preferably 40% to 80%.

4. Image Forming Apparatus

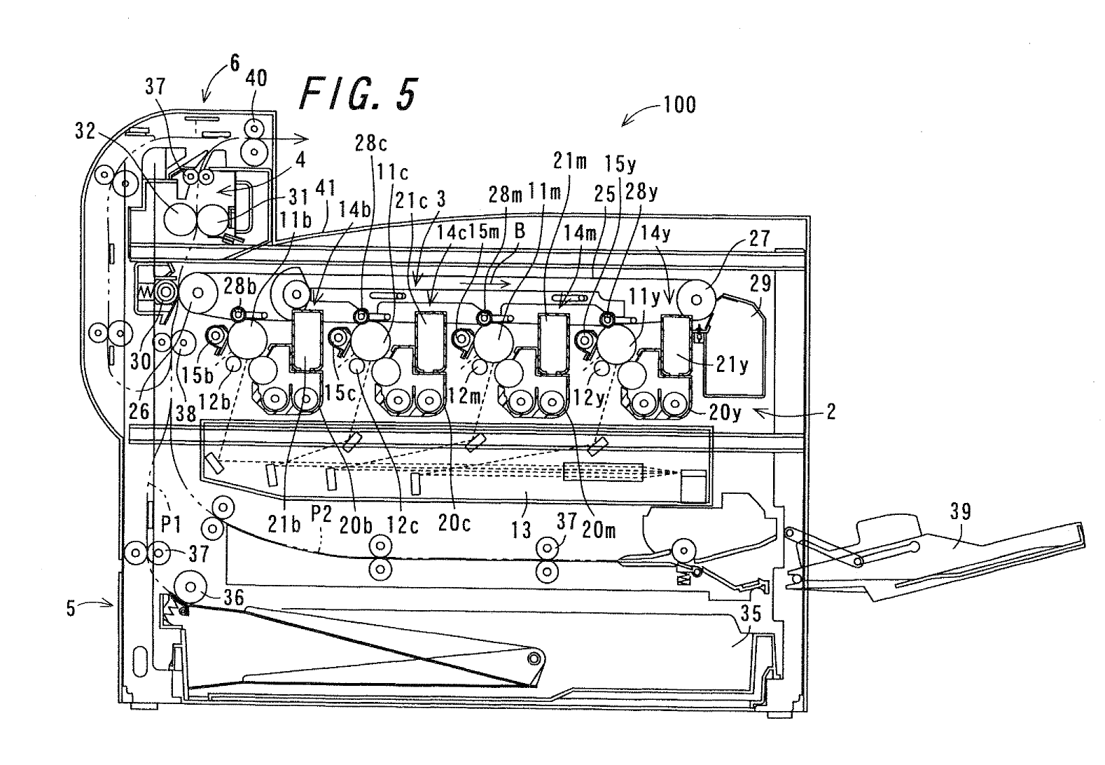

FIG. 5 is a sectional view schematically showing a configuration of an image forming apparatus 100 according to an embodiment of the invention. The image forming apparatus 100 is a multifunction peripheral which combines a copier function, a printer function, and a facsimile function. In the image forming apparatus 100, according to image information transmitted thereto, a full-color or black-and-white image is formed on a recording medium. To be specific, three print modes, i.e., a copier mode, a printer mode, and a facsimile mode are available in the image forming apparatus 100, one of which print modes is selected by a control unit (not shown) in response to an operation input given by an operating section (not shown) or a print job given by a personal computer, a mobile computer, an information record storage medium, or an external equipment having a memory unit.

The image forming apparatus 100 includes a photoreceptor drum 11, a toner image forming section 2, a transfer section 3, a fixing section 4, a recording medium feeding section 5, and a discharging section 6. In accordance with image information of respective colors of black (b), cyan (c), magenta (m), and yellow (y) which are contained in color image information, there are provided respectively four sets of the components constituting the toner image forming section 2 and some parts of the components contained in the transfer section 3. The four sets of respective components provided for the respective colors are distinguished herein by giving alphabets indicating the respective colors to the end of the reference numerals, and in the case where the sets are collectively referred to, only the reference numerals are shown.

The toner image forming section 2 includes a charging section 12, an exposure unit 13, a developing device 14, and a cleaning unit 15. The charging section 12 and the exposure unit 13 functions as a latent image forming section. The charging section 12, the developing device 14, and the cleaning unit 15 are disposed in the order just stated around the photoreceptor drum 11. The charging section 12 is disposed vertically below the developing device 14 and the cleaning unit 15.

The photoreceptor drum 11 is a roller-like member provided so as to be capable of rotationally driving around an axis by a rotary driving section (not shown) and on the surface of which an electrostatic latent image is formed. The rotary driving section of the photoreceptor drum 11 is controlled by a control unit that is realized by a central processing unit (CPU). The photoreceptor drum 11 comprises a conductive substrate (not shown) and a photosensitive layer (not shown) formed on the surface of the conductive substrate. The conductive substrate may assume various shapes including a cylindrical shape, a columnar shape, or a thin film sheet shape, for example. Among them, the cylindrical shape is preferable. The conductive substrate is formed by a conductive material.

As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as a synthetic resin film, a metal film, and paper; and a resin composition containing conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for example, by stacking a charge generating layer containing a charge generating substance, and a charge transporting layer containing a charge transporting substance. In this case, an undercoat layer is preferably formed between the conductive substrate and the charge generating layer or the charge transporting layer. When the undercoat layer is provided, the flaws and irregularities present on the surface of the conductive substrate are covered, leading to advantages such that the photosensitive layer has a smooth surface, that chargeability of the photosensitive layer can be prevented from degrading during repetitive use, and that the chargeability of the photosensitive layer can be enhanced under at least either a low temperature circumstance or a low humidity circumstance. Further, a laminated photoreceptor is also applicable which has a highly-durable three-layer structure having a photoreceptor surface-protecting layer provided on the top layer.

The charge generating layer contains as a main substance a charge generating substance that generates charges under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton, or distyryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generating ability and are suitable for forming a highly-sensitive photosensitive layer. The charge generating substances may be used each alone, or two or more of them may be used in combination. The content of the charge generating substance is not particularly limited, and preferably from 5 parts by weight to 500 parts by weight and more preferably from 10 parts by weight to 200 parts by weight based on 100 parts by weight of the binder resin in the charge generating layer. Also as the binder resin for charge generating layer, materials used customarily in the relevant field can be used including, for example, melamine resin, epoxy resin, silicone resin, polyurethane, acrylic resin, vinyl chloride-vinyl acetate copolymer resin, polycarbonate, phenoxy resin, polyvinyl butyral, polyallylate, polyamide, and polyester. The binder resin may be used each alone or optionally two or more of them may be used in combination.

The charge generating layer can be formed by dissolving or dispersing an appropriate amount of a charge generating substance, binder resin and, optionally, a plasticizer, a sensitizer, etc., respectively in an appropriate organic solvent which is capable of dissolving or dispersing the substances described above, to thereby prepare a coating solution for charge generating layer, and then applying the coating solution for charge generating layer to the surface of the conductive substrate, followed by drying. The thickness of the charge generating layer obtained in this way is not particularly limited, and preferably from 0.05 μm to 5 μm and more preferably from 0.1 μm to 2.5 μm.

The charge transporting layer stacked over the charge generating layer contains as essential substances a charge transporting substance having an ability of receiving and transporting charges generated from the charge generating substance, and binder resin for charge transporting layer, and optionally contains known antioxidant, plasticizer, sensitizer, lubricant, etc. As the charge transporting substance, materials used customarily in the relevant field can be used including, for example: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, bromanil, chloranil, and benzoquinone. The charge transporting substances may be used each alone, or two or more of them may be used in combination. The content of the charge transporting substance is not particularly limited, and preferably from 10 parts by weight to 300 parts by weight and more preferably from 30 parts by weight to 150 parts by weight based on 100 parts by weight of the binder resin in the charge transporting layer.

As the binder resin for charge transporting layer, it is possible to use materials which are used customarily in the relevant field and capable of uniformly dispersing the charge transporting substance, including, for example, polycarbonate, polyallylate, polyvinylbutyral, polyamide, polyester, polyketone, epoxy resin, polyurethane, polyvinylketone, polystyrene, polyacrylamide, phenolic resin, phenoxy resin, polysulfone resin, and copolymer resin thereof. Among those materials, in view of the film forming property, and the wear resistance, an electrical property etc. of the obtained charge transporting layer, it is preferable to use, for example, polycarbonate which contains bisphenol Z as the monomer ingredient (hereinafter referred to as “bisphenol Z polycarbonate”), and a mixture of bisphenol Z polycarbonate and other polycarbonate. The binder resin may be used each alone, or two or more of them may be used in combination.

The charge transporting layer preferably contains an antioxidant together with the charge transporting substance and the binder resin for charge transporting layer. Also for the antioxidant, substances used customarily in the relevant field can be used including, for example, Vitamin E, hydroquinone, hindered amine, hindered phenol, paraphenylene diamine, arylalkane and derivatives thereof, an organic sulfur compound, and an organic phosphorus compound. The antioxidants may be used each alone, or two or more of them may be used in combination. The content of the antioxidant is not particularly limited, and is 0.01% by weight to 10% by weight and preferably 0.05% by weight to 5% by weight of the total amount of the ingredients constituting the charge transporting layer.

The charge transporting layer can be formed by dissolving or dispersing an appropriate amount of a charge transporting substance, binder resin and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer to the surface of a charge generating layer followed by drying. The thickness of the charge transporting layer obtained in this way is not particularly limited, and preferably 10 μm to 50 μm and more preferably 15 μm to 40 μm.

Note that it is also possible to form a photosensitive layer in which a charge generating substance and a charge transporting substance are present in one layer. In this case, the kind and content of the charge generating substance and the charge transporting substance, the kind of the binder resin, and other additives may be the same as those in the case of forming separately the charge generating layer and the charge transporting layer.

In the embodiment, there is used a photoreceptor drum which has an organic photosensitive layer as described above containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 longitudinally along the photoreceptor drum 11. The charging section 12 charges the surface of the photoreceptor drum 11 so that the surface of the photoreceptor drum 11 has predetermined polarity and potential. As the charging section 12, it is possible to use a charging brush type charging device, a charger type charging device, a pin array type charging device, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in pressure-contact with the photoreceptor drum. It is also possible to use a contact-charging type charger such as a charging brush or a magnetic brush.

The exposure unit 13 is disposed so that a light beam corresponding to each color information emitted from the exposure unit 13 passes between the charging section 12 and the developing device 14 and reaches the surface of the photoreceptor drum 11. In the exposure unit 13, the image information is converted into light beams corresponding to each color information of black, cyan, magenta, and yellow, and the surface of the photoreceptor drum 11 which has been evenly charged by the charging section 12, is exposed to the light beams corresponding to each color information to thereby form electrostatic latent images on the surfaces of the photoreceptor drums 11. As the exposure unit 13, it is possible to use a laser scanning unit having a laser-emitting portion and a plurality of reflecting mirrors. The other usable examples of the exposure unit 13 may include an LED array or a unit in which a liquid-crystal shutter and a light source are appropriately combined with each other.

The cleaning unit 15 removes the toner which remains on the surface of the photoreceptor drum 11 after the toner image has been transferred to the recording medium, and thus cleans the surface of the photoreceptor drum 11. In the cleaning unit 15, a plate-like member is used such as a cleaning blade. In the image forming apparatus 100 of the invention, an organic photoreceptor drum is mainly used as the photoreceptor drum 11. A surface of the organic photoreceptor drum contains a resin component as a main ingredient and therefore tends to be degraded by chemical action of ozone which is generated by corona discharging of the charging section. The degraded surface part is, however, worn away by abrasion through the cleaning unit 15 and thus removed reliably, though gradually. Accordingly, the problem of the surface degradation caused by the ozone, etc. is actually solved, and it is thus possible to stably maintain the potential of charges given by the charging operation over a long period of time. Although the cleaning unit 15 is provided in the embodiment, no limitation is imposed on the configuration and the cleaning unit 15 does not have to be provided.

In the toner image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing device 14 to the electrostatic latent image, thereby forming a toner image; the toner image is transferred to an intermediate transfer belt 25; and the toner which remains on the surface of the photoreceptor drum 11 is removed by the cleaning unit 15. A series of toner image forming operations just described are repeatedly carried out.

The transfer section 3 is disposed above the photoreceptor drum 11 and includes the intermediate transfer belt 25, a driving roller 26, a driven roller 27, an intermediate transferring roller 28, a transfer belt cleaning unit 29, and a transferring roller 30. The intermediate transfer belt 25 is an endless belt-like member supported around the driving roller 26 and the driven roller 27 with tension, thereby forming a loop-shaped travel path. The intermediate transfer belt 25 rotates in an arrow B direction. The driving roller 26 is disposed capable of rotating around its own axis by a driving portion (not shown), and rotates the intermediate transfer belt 25 in the arrow B direction by the rotation. The driven roller 27 can be driven to rotate by the rotation of the driving roller 26, and imparts constant tension to the intermediate transfer belt 25 so that the intermediate transfer belt 25 does not go slack. The intermediate transferring roller 28 is disposed in pressure-contact with the photoreceptor drum 11 with the intermediate transfer belt 25 interposed therebetween, and capable of rotating around its own axis by a driving portion (not shown). The intermediate transferring roller 28 is connected to a power source (not shown) for applying the transfer bias voltage as described above, and has a function of transferring the toner image formed on the surface of the photoreceptor drum 11 to the intermediate transfer belt 25.

When the intermediate transfer belt 25 passes by the photoreceptor drum 11 in contact therewith, the transfer bias voltage whose polarity is opposite to the polarity of the charged toner on the surface of the photoreceptor drum 11 is applied from the intermediate transferring roller 28 which is disposed opposite to the photoreceptor drum 11 with the intermediate transfer belt 25 interposed therebetween, with the result that the toner image formed on the surface of the photoreceptor drum 11 is transferred onto the intermediate transfer belt 25. In the case of a multicolor image, the toner images of respective colors formed on the respective photoreceptor drums 11 are sequentially transferred and overlaid onto the intermediate transfer belt 25, thus forming a multicolor toner image.

The transfer belt cleaning unit 29 is disposed opposite to the driven roller 27 with the intermediate transfer belt 25 interposed therebetween so as to come into contact with an outer circumferential surface of the intermediate transfer belt 25. When the intermediate transfer belt 25 contacts the photoreceptor drum 11, the toner is attached to the intermediate transfer belt 25 and may cause contamination on a reverse side of the recording medium, and therefore the transfer belt cleaning unit 29 removes and collects the toner on the surface of the intermediate transfer belt 25.

The transferring roller 30 is disposed in pressure-contact with the driving roller 26 with the intermediate transfer belt 25 interposed therebetween, and capable of rotating around its own axis by a driving portion (not shown). In a pressure-contact portion (a transfer nip region) between the transferring roller 30 and the driving roller 26, a toner image which has been borne by the intermediate transfer belt 25 and thereby conveyed to the pressure-contact portion is transferred onto a recording medium fed from the later-described recording medium feeding section S. The recording medium bearing the toner image is fed to the fixing section 4.

In the transfer section 3, the toner image is transferred from the photoreceptor drum 11 onto the intermediate transfer belt 25 in the pressure-contact portion between the photoreceptor drum 11 and the intermediate transferring roller 28, and by the intermediate transfer belt 25 rotating in the arrow B direction, the transferred toner image is conveyed to the transfer nip region where the toner image is transferred onto the recording medium.

The fixing section 4 is disposed downstream from the transfer section 3 with respect to the direction in which the recording medium is conveyed, and includes a fixing roller 31 and a pressure roller 32. The fixing roller 31 is so disposed as to be driven to rotate by a driving portion (not shown), and fuses a yet-to-be-fixed toner image borne on the recording medium by heating the toner constituting the toner image. In the interior of the fixing roller 31 is disposed a heating portion (not shown). The heating portion applies heat to the fixing roller 31 in such a manner that the temperature of the surface of the heating roller 31 can be raised to a predetermined temperature (hereafter also referred to as “heating temperature”). As the heating portion, for example, a heater, a halogen lamp, or the like can be used. The heating portion is controlled by a fixing condition control section.

In the vicinity of the surface of the fixing roller 31 is provided a temperature detecting sensor (not shown) which detects a surface temperature of the fixing roller 31. A result detected by the temperature detecting sensor is written to a memory portion of the later-described control unit. The pressure roller 32 is disposed in pressure-contact with the fixing roller 31, and supported so as to be driven to rotate by the rotation of the fixing roller 31. The pressure roller 32 fixes the toner image onto the recording medium in cooperation with the fixing roller 31. At this time, the pressure roller 32 helps the toner image in the fused state by the heat from the fixing roller 31, to be fixed onto the recording medium by pressing the toner image against the recording medium by the fixing roller 31. A pressure-contact portion between the fixing roller 31 and the pressure roller 32 is a fixing nip region.

In the fixing section 4, the recording medium onto which the toner image has been transferred in the transfer section 3 is nipped by the fixing roller 31 and the pressure roller 32 so that when the recording medium passes through the fixing nip region, the toner image is pressed and thereby fixed onto the recording medium under heat, whereby an image is formed.

The recording medium feeding section 5 includes an automatic paper feed tray 35, a pickup roller 36, conveying rollers 37, registration rollers 38, and a manual paper feed tray 39. The automatic paper feed tray 35 is disposed in a vertically lower part of the image forming apparatus 100 and in form of a container-shaped member for storing the recording mediums. Examples of the recording medium include plain paper, color copy paper, sheets for overhead projector, and postcards. The pickup roller 36 takes out sheet by sheet the recording mediums stored in the automatic paper feed tray 35, and feeds the recording mediums to a paper conveyance path P1. The conveying rollers 37 are a pair of roller members disposed in pressure-contact with each other, and convey the recording medium to the registration rollers 38. The registration rollers 38 are a pair of roller members disposed in pressure-contact with each other, and feed to the transfer nip region the recording medium fed from the conveying rollers 37 in synchronization with the conveyance of the toner image borne on the intermediate transfer belt 25 to the transfer nip region. The manual paper feed tray 39 is a device for storing recording mediums which are different from the recording mediums stored in the automatic paper feed tray 35 and may have any size and which are to be taken into the image forming apparatus 100. The recording medium taken in from the manual paper feed tray 39 passes through a paper conveyance path P2 by use of the conveying rollers 37, thereby being fed to the registration rollers 38. In the recording medium feeding section 5, the recording medium supplied sheet by sheet from the automatic paper feed tray 35 or the manual paper feed tray 39 is fed to the transfer nip region in synchronization with the conveyance of the toner image borne on the intermediate transfer belt 25 to the transfer nip region.

The discharging section 6 includes the conveying rollers 37, discharging rollers 40, and a catch tray 41. The conveying rollers 37 are disposed downstream of the fixing nip region along the paper conveyance direction, and convey toward the discharging rollers 40 the recording medium onto which the image has been fixed by the fixing section 4. The discharging rollers 40 discharge the recording medium onto which the image has been fixed, to the catch tray 41 disposed on a vertically upper surface of the image forming apparatus 100. The catch tray 41 stores the recording medium onto which the image has been fixed.

The image forming apparatus 100 includes a control unit (not shown). The control unit is disposed, for example, in an upper part of an internal space of the image forming apparatus 100, and contains a memory portion, a computing portion, and a control portion. To the memory portion of the control unit are inputted, for example, various set values obtained by way of an operation panel (not shown) disposed on the upper surface of the image forming apparatus 100, results detected from a sensor (not shown) etc. disposed in various portions inside the image forming apparatus 100, and image information obtained from an external equipment. Further, programs for operating various functional elements are written. Examples of the various functional elements include a recording medium determining portion, an attachment amount controlling portion, and a fixing condition controlling portion. For the memory portion, those customarily used in the relevant filed can be used including, for example, a read only memory (ROM), a random access memory (RAM), and a hard disk drive (HDD). For the external equipment, it is possible to use electrical and electronic devices which can form or obtain the image information and which can be electrically connected to the image forming apparatus 100. Examples of the external equipment include a computer, a digital camera, a television receiver, a video recorder, a DVD (digital versatile disc) recorder, an HDDVD (high-definition digital versatile disc), a Blu-ray disc recorder, a facsimile machine, and a mobile terminal device. The computing portion of the control unit takes out the various data (such as an image formation order, the detected result, and the image information) written in the memory portion and the programs for various functional elements, and then makes various determinations. The control portion of the control unit sends to a relevant device a control signal in accordance with the result determined by the computing portion, thus performing control on operations. The control portion and the computing portion include a processing circuit which is achieved by a microcomputer, a microprocessor, etc. having a central processing unit. The control unit contains a main power source as well as the above-stated processing circuit. The power source supplies electricity to not only the control unit but also respective devices provided inside the image forming apparatus 100.

5. Developing Device

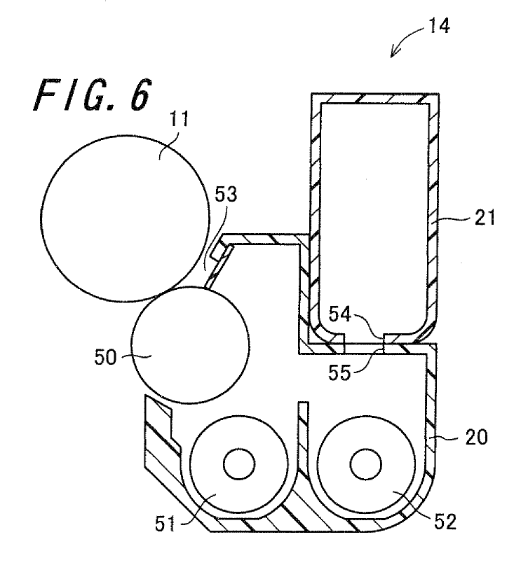

FIG. 6 is a schematic view schematically showing the developing device 14 provided in the image forming apparatus 100 shown in FIG. 5. The developing device 14 includes a developing tank 20 and a toner hopper 21. The developing tank 20 is a container-shaped member which is disposed so as to face the surface of the photoreceptor drum 11 and used to supply a toner to an electrostatic latent image formed on the surface of the photoreceptor drum 11 so as to develop the electrostatic latent image into a visualized image, i.e. a toner image. The developing tank 20 contains in an internal space thereof the toner, and rotatably supports roller members such as a developing roller 50, a supplying roller 51, and an agitating roller 52. Moreover, a screw member may be stored instead of the roller-like member. The developing device 14 of this embodiment stores the toner of the above embodiment in the developing tank 20 as a toner.

The developing tank 20 has an opening 53 in a side face thereof opposed to the photoreceptor drum 11. The developing roller 50 is rotatably provided at such a position as to face the photoreceptor drum 11 through the opening 53 just stated. The developing roller 50 is a roller-shaped member for supplying a toner to the electrostatic latent image on the surface of the photoreceptor drum 11 in a pressure-contact portion or most-adjacent portion between the developing roller 50 and the photoreceptor drum 11. In supplying the toner, to a surface of the developing roller 50 is applied potential whose polarity is opposite to polarity of the potential of the charged toner, which serves as development bias voltage. By so doing, the toner on the surface of the developing roller 50 is smoothly supplied to the electrostatic latent image. Furthermore, an amount of the toner being supplied to the electrostatic latent image (which amount is referred to as “toner attachment amount”) can be controlled by changing a value of the development bias voltage.

The supplying roller 51 is a roller-shaped member which is rotatably disposed so as to face the developing roller 50 and used to supply the toner to the vicinity of the developing roller 50.

The agitating roller 52 is a roller-shaped member which is rotatably disposed so as to face the supplying roller 51 and used to feed to the vicinity of the supplying roller 51 the toner which is newly supplied from the toner hopper 21 into the developing tank 20. The toner hopper 21 is disposed so as to communicate a toner replenishment port 54 formed in a vertically lower part of the toner hopper 21, with a toner reception port 55 formed in a vertically upper part of the developing tank 20. The toner hopper 21 replenishes the developing tank 20 with the toner according to toner consumption. Further, it may be possible to adopt such configuration that the developing tank 20 is replenished with the toner supplied directly from a toner cartridge of each color without using the toner hopper 21.

As described above, since the developing device 14 develops a latent image using the developer of the invention, it is possible to stably form a high-definition toner image on the photoreceptor drum 11. As a result, it is possible to form a high-quality image stably.

Moreover, according to the invention, the image forming apparatus 100 is realized by including the photoreceptor drum 11 on which a latent image is formed, the charging section 12 that forms the latent image on the photoreceptor drum 11, the exposure unit 13, and the developing device 14 of the invention capable of forming a high-definition toner image on the photoreceptor drum 11 as described above. By forming an image with such an image forming apparatus 100, it is possible to form an image having high definition and excellent image quality without unevenness in density.

### Examples

Hereinafter, referring to examples and comparative examples, the invention will be specifically described. In the following description, unless otherwise noted, “parts” and “%” represent “parts by weight” and “% by weight” respectively. In the examples and the comparative examples, a glass transition temperature of the binder resin and the toner base particle, a softening temperature of the binder resin, a melting point of the release agent, and a volume average particle size of the toner base particles were measured as follows.

[Glass Transition Temperature of Binder Resin and Toner Base Particle]

Using a differential scanning calorimeter (trade name: DSC220, manufactured by Seiko Instruments & Electronics Ltd.), 1 g of specimen was heated at a temperature increasing rate of 10° C./min to measure a DSC curve based on Japanese Industrial Standards (JIS) K7121-1987. A temperature at an intersection of a straight line that was elongated toward a low-temperature side from a base line on the high-temperature side of an endothermic peak corresponding to glass transition of the obtained DSC curve and a tangent line that was drawn so that a gradient thereof was maximum against a curve extending from a rising part to a top of the peak was obtained as the glass transition temperature (T_{g}).

[Softening Temperature of Binder Resin]

Using a flow characteristic evaluation apparatus (trade name: FLOW TESTER CFT-100C, manufactured by Shimadzu Corporation), 1 g of specimen was heated at a temperature increasing rate of 6° C./min, under load of 20 kgf/cm² (19.6×10⁵ Pa) so that the specimen was pushed out of a dye (nozzle opening diameter of 1 mm and length of 1 mm) and a temperature at the time when a half of the specimen had flowed out of the dye was obtained as the softening temperature (Tₘ).

[Melting Point of Release Agent]

Using the differential scanning calorimeter (trade name: DSC220, manufactured by Seiko Instruments & Electronics Ltd.), 1 g of specimen was heated from a temperature of 20 up to 200° C. at a temperature increasing rate of 10° C./min, and then an operation of rapidly cooling down from 200° C. to 20° C. was repeated twice, thus measuring a DSC curve. A temperature at a top of an endothermic peak corresponding to the melting on the DSC curve measured at the second operation, was obtained as the melting point of the release agent.

[Volume Average Particle Size]

To 50 ml of electrolyte (trade name: ISOTON-II, manufactured by Beckman Coulter, Inc.), 20 mg of specimen and 1 ml of sodium alkylether sulfate ester were added, and a thus-obtained admixture was subjected to dispersion processing of an ultrasonic distributor (trade name: desktop two-frequency ultrasonic cleaner VS-D100, manufactured by AS ONE Corporation) for three minutes at an ultrasonic frequency of 20 kHz, thereby preparing a specimen for measurement. The measurement sample was analyzed by a particle size distribution-measuring device: MULTISIZER III (trade name) manufactured by Beckman Coulter, Inc. under the conditions that an aperture diameter was 100 μm and the number of particles for measurement was 50,000 counts. A volume particle size distribution of the sample particles was thus obtained from which the volume average particle size was then determined.

<Influence of LEL Concentration Coefficient (Spray Liquid: ethanol)>

Ethanol (molecular weight: 46.07, LEL concentration: 3.3% by volume) was used as the spray liquid. The LEL concentration coefficient within the powder passage was caused to vary by changing the volume of the powder passage interior and the ethanol supply rate. In this way, evaluation has been conducted in terms of the influence of the LEL concentration coefficient exerted upon the coating uniformity of the resin coating layer, the yield, and the inclusion of coarse particles.

### Example 1

### [Toner Base Particle Preparation Step S1]

Raw materials of the toner base particles and addition amounts thereof were as follows:

| | | |
|---|---|---|
| Polyester resin (trade name: DIACRON, | 87.5% | (100 parts) |
| manufactured by Mitsubishi Rayon Co., Ltd., | | |
| glass transition temperature of 55° C., | | |
| softening temperature of 130° C.) | | |
| C.I. Pigment Blue 15:3 | 5.0% | (5.7 parts) |
| Release agent (Carunauba Wax, melting point | 6.0% | (6.9 parts) |
| of 82° C.) | | |
| Charge control agent (trade name: Bontron E84, | 1.5% | (1.7 parts) |
| manufactured by Orient Chemical Industries, Ltd.) | | |

After pre-mixing each of the constituent materials described above by a Henschel mixer (trade name: FM20C, manufactured by Mitsui Mining Co., Ltd.), the obtained mixture was melt and kneaded by a twin-screw extruder (trade name: PCM65 manufactured by Ikegai, Ltd.). After coarsely pulverizing the melt-kneaded material by a cutting mill (trade name: VM-16, manufactured by Orient Co., Ltd.), it was finely pulverized by a jet mill (manufactured by Hosokawa Micron Corporation) and then classified by a pneumatic classifier (manufactured by Hosokawa Micron Corporation) to produce toner base particles with a volume average particle size of 6.5 μm and a glass transition temperature of 56° C.

[Fine Resin Particle Preparation Step S2]

A polymer of styrene and butyl acrylate was freeze-dried to make fine resin particles, thereby obtaining styrene butyl acrylate copolymer fine particles (glass transition temperature of 72° C. and softening temperature of 126° C.) with a volume average particle size of 0.1 μm.

[Coating Step S3]

An apparatus incorporating a two-fluid nozzle that follows the construction of the toner manufacturing apparatus 201 of the invention as shown in FIG. 2 was used in this step. As the liquid spraying unit, commercially available ones may be used. For example, a unit constructed of a combination of a liquid-feeding pump (trade name: SP11-12, manufactured by FLOM Co., Ltd.) and a two-fluid nozzle (trade name: Type HM-6, manufactured by FUSO SEIKI Co., Ltd.) may be used. In this construction, a substance in liquid form is fed in a fixed amount to the two-fluid nozzle through the liquid-feeding pump. Supply rate of substance in liquid form and gas discharge rate may be observed by means of a commercially available gas detector (trade name: XP-3110, manufactured by NEW COSMOS ELECTRIC Co., Ltd.).

The temperature regulation jacket was provided over the entire surface of the powder flowing section and the wall surface of the stirring section. A temperature sensor was installed in the powder passage. A temperature of the powder flowing section and the stirring section was regulated to 55° C. In the above-described apparatus, a peripheral speed in the outermost peripheral of the rotary stirring section of the Hybridization system was 100 m/sec at the fine resin particle adhering step to the surface of toner base particles. The peripheral speed was also 100 m/sec at the spraying step and the film-forming step. Moreover, an installation angle of the two-fluid nozzle was set so that an angle formed by the substance in the form of liquid spraying direction and the powder flowing direction (hereinafter referred to as “spraying angle”) is in parallel (0°).

In such an apparatus, 400 parts by weight of the toner base particles and 40 parts by weight of the fine resin particles thereby prepared have been mixed with stirring in the powder passage (interior volume: 26.79 L) for 5 minutes. Then, the toner base particles and, the fine resin particles in a fluidized state under stirring have been sprayed with a spray liquid i.e. ethanol. (molecular weight: 46.07, LEL concentration: 3.3% by volume) for 30 minutes under conditions where the rate at which ethanol is supplied from the two-fluid nozzle is 0.500 g/min and the supply of air acting as a carrier gas is 5 L/min, whereupon the fine resin particles were changed to a film state on the toner base particles. After that, the ethanol spray treatment was brought to an end and 5-minute stirring have been carried out. In this way, a toner of Example 1 was obtained. At this time, the gasification volume and the LEL concentration coefficient within the powder passage were 0.24 L/min and 0.27, respectively. Note that the supply of air which is admitted into the apparatus is set at 10 L/min. More specifically, the supply of air which is admitted via the rotary shaft into the apparatus is adjusted to 5 L/min, and the supply of air from the two-fluid nozzle is 5 L/min. When these values are added together, it comes to 10 L/min. Thus, the air is discharged out of the powder passage in a discharge amount equal to the total sum of air supply (10 L/min).

### Example 2

A toner of Example 2 was obtained in the same manner as in Example 1, except that, in the coating step, the volume of the powder passage interior was changed from 26.79 L to 3.63 L, and 100 parts by weight of the toner base particles and 10 parts by weight of the fine resin particles were put into the powder passage. At this time, the gasification volume and the LEL concentration coefficient within the powder passage were 0.24 L/min and 2.03, respectively.

### Example 3

A toner of Example 3 was obtained in the same manner as in Example 1, except that, in the coating step, the volume of the powder passage interior was changed from 26.79 L to 39.66 L, and 600 parts by weight of the toner base particles and 60 parts by weight of the fine resin particles were put into the powder passage. At this time, the gasification volume and the LEL concentration coefficient within the powder passage were 0.24 L/min and 0.19, respectively.

### Example 4

A toner of Example 4 was obtained in the same manner as in Example 1, except that, in the coating step, the volume of the powder passage interior was changed from 26.79 L to 2.00 L, and 60 parts by weight of the toner base particles and 6 parts by weight of the fine resin particles were put into the powder passage. At this time, the gasification volume and the LEL concentration coefficient within the powder passage were 0.24 L/min and 3.68, respectively.

### Example 5

A toner of Example 5 was obtained in the same manner as in Example 1, except that, in the coating step, the ethanol supply rate was changed from 0.500 g/min to 0.125 g/min. At this time, the gasification volume and the LEL concentration coefficient within the powder passage were 0.06 L/min and 0.07, respectively.

### Example 6

A toner of Example 6 was obtained in the same manner as in Example 1, except that, in the coating step, the ethanol supply rate was changed from 0.500 g/min to 1.000 g/min. At this time, the gasification volume and the LEL concentration coefficient within the powder passage were 0.49 L/min and 0.55, respectively.

### Example 7

A toner of Example 7 was obtained in the same manner as in Example 1, except that, in the coating step, the ethanol supply rate was changed from 0.500 g/min to 2.000 g/min. At this time, the gasification volume and the LEL concentration coefficient, within the powder passage were 0.97 L/min and 1.10, respectively.

### Example 8

A toner of Example 8 was obtained in the same manner as in Example 1, except that, in the coating step, the ethanol supply rate was changed from 0.500 g/min to 2.500 g/min. At this time, the gasification volume and the LEL concentration coefficient within the powder passage were 1.22 L/min and 1.37, respectively.

### Example 9

A toner of Example 9 was obtained in the same manner as in Example 1, except that, in the coating step, the ethanol supply rate was changed from 0.500 g/min to 3.000 g/min. At this time, the gasification volume and the LEL concentration coefficient within the powder passage were 1.46 L/min and 1.65, respectively.

### Example 10

A toner of Example 10 was obtained in the same manner as in Example 2, except that, in the coating step, the ethanol supply rate was changed from 0.500 g/min to 0.125 g/min. At this time, the gasification volume and the LEL concentration coefficient within the powder passage were 0.06 L/min and 0.51, respectively.

### Example 11

A toner of Example 11 was obtained in the same manner as in Example 2, except that, in the coating step, the ethanol supply rate was changed from 0.500 g/min to 1.000 g/min. At this time, the gasification volume and the LEL concentration coefficient within the powder passage were 0.49 L/min and 4.06, respectively.

### Example 12

A toner of Example 12 was obtained in the same manner as in Example 2, except that, in the coating step, the ethanol supply rate was changed from 0.500 g/min to 2.000 g/min. At this time, the gasification volume and the LEL concentration coefficient within the powder passage were 0.97 L/min and 8.12, respectively.

### Example 13

A toner of Example 13 was obtained in the same manner as in Example 3, except that, in the coating step, the ethanol supply rate was changed from 0.500 g/min to 1.000 g/min. At this time, the gasification volume and the LEL concentration coefficient within the powder passage were 0.49 L/min and 0.37, respectively.

### Example 14

A toner of Example 14 was obtained in the same manner as in Example 3, except that, in the coating step, the ethanol supply rate was changed from 0.500 g/min to 2.000 g/min. At this time, the gasification volume and the LEL concentration coefficient within the powder passage were 0.97 L/min and 0.74, respectively.

### Example 15

A toner of Example 15 was obtained in the same manner as in Example 3, except that, in the coating step, the ethanol supply rate was changed from 0.500 g/min to 2.500 g/min. At this time, the gasification volume and the LEL concentration coefficient within the powder passage were 1.22 L/min and 0.93, respectively.

### Example 16

A toner of Example 16 was obtained in the same manner as in Example 3, except that, in the coating step, the ethanol supply rate was changed from 0.500 g/min to 3.000 g/min. At this time, the gasification volume and the LEL concentration coefficient within the powder passage were 1.46 L/min and 1.11, respectively.

### Example 17

A toner of Example 17 was obtained in the same manner as in Example 4, except that, in the coating step, the ethanol supply rate was changed from 0.500 g/min to 0.125 g/min. At this time, the gasification volume and the LEL concentration coefficient within the powder passage were 0.06 L/min and 0.92, respectively.

### Example 18

A toner of Example 18 was obtained in the same manner as in Example 4, except that, in the coating step, the ethanol supply rate was changed from 0.500 g/min to 1.000 g/min. At this time, the gasification volume and the LEL concentration coefficient within the powder passage were 0.49 L/min and 7.37, respectively.

### Comparative Example 1

A toner of Comparative Example 1 was obtained in the same manner as in Example 1, except that ethanol (spray liquid) spray treatment was not conducted.

### Comparative Example 2

A toner of Comparative Example 2 was obtained in the same manner as in Example 2, except that ethanol (spray liquid) spray treatment was not conducted.

### Comparative Example 3

A toner of Comparative Example 3 was obtained in the same manner as in Example 2, except that, in the coating step, the ethanol supply rate was changed from 0.500 g/min to 2.500 g/min. At this time, the gasification volume and the LEL concentration coefficient within the powder passage were 1.22 L/min and 10.15, respectively.

### Comparative Example 4

A toner of Comparative Example 4 was obtained in the same manner as in Example 2, except that, in the coating step, the ethanol supply rate was changed from 0.500 g/min to 3.000 g/min. At this time, the gasification volume and the LEL concentration coefficient within the powder passage were 1.46 L/min and 12.18, respectively.

### Comparative Example 5

A toner of Comparative Example 5 was obtained in the same manner as in Example 3, except that ethanol (spray liquid) spray treatment was not conducted.

### Comparative Example 6

A toner of Comparative Example 6 was obtained in the same manner as in Example 3, except that, in the coating step, the ethanol supply rate was changed from 0.500 g/min to 0.125 g/min. At this time, the gasification volume and the LEL concentration coefficient within the powder passage were 0.06 L/min and 0.05, respectively.

### Comparative Example 7

A toner of Comparative Example 7 was obtained in the same manner as in Example 4, except that ethanol (spray liquid) spray treatment was not conducted.

### Comparative Example 8

A toner of Comparative Example 8 was obtained in the same manner as in Example 4, except that, in the coating step, the ethanol supply rate was changed from 0.500 g/min to 2.000 g/min. At this time, the gasification volume and the LEL concentration coefficient within the powder passage were 0.97 L/min and 14.73, respectively.

### Comparative Example 9

A toner of Comparative Example 9 was obtained in the same manner as in Example 4, except that, in the coating step, the ethanol supply rate was changed from 0.500 g/min to 2.500 g/min. At this time, the gasification volume and the LEL concentration coefficient within the powder passage were 1.22 L/min and 18.42, respectively.

### Comparative Example 10

A toner of Comparative Example 10 was obtained in the same manner as in Example 4, except that, in the coating step, the ethanol supply rate was changed from 0.500 g/min to 3.000 g/min. At this time, the gasification volume and the LEL concentration coefficient within the powder passage were 1.46 L/min and 22.10, respectively.

### Comparative Example 11

A toner of Comparative Example 11 was obtained in the same manner as in Example 4, except that, in the coating step, the ethanol supply rate was changed from 0.500 g/min to 2.250 g/min. At this time, the gasification volume and the LEL concentration coefficient within the powder passage were 1.09 L/min and 9.13, respectively.

The toners of Examples 1 through 18 and Comparative Examples 1 through 11 thereby obtained have been evaluated in terms of coating uniformity and yield as follows.

[Coating Uniformity]

With use of the toners of Examples and Comparative Examples, coating uniformity evaluation has been conducted by checking the presence or absence of aggregates on the toner that has been stored under a high-temperature condition. More specifically, 20 g of the toner was hermetically sealed in a plastic container and left standing at 50° C. for 48 hours. After that, the toner was taken out and sifted through a 230-mesh sieve to measure the weight of toner portions remaining on the sieve. Then, the ratio in weight of the remaining toner to the entire toner, i.e. a residual toner amount was obtained to conduct coating uniformity evaluation in accordance with the following evaluation criterion. Note that, the smaller is the numerical value, the less likely it is that toner blocking occurs; that is, the better the storage stability.

The evaluation criterion is as follows:

Excellent: No aggregates. The residual toner amount is less than 1%.

Good: Aggregates in trace amounts. The residual toner amount is greater than or equal to 1% but less than 3%.

Not bad: Aggregates in small amounts. The residual toner amount is greater than or equal to 3% but less than 20%.

Poor: Aggregate in large amounts. The residual toner amount is greater than 20%.

<Yield>

The toner yield was calculated by the following formula (5) and the yield of the toners manufactured by the manufacturing methods of the Examples and Comparative Examples was evaluated.

Toner yield (%)={Weight of collected toner particles/(Weight of inputted toner base particles Weight of solid fine resin particles)}×100 (5)

An evaluation criterion is as follows:

Excellent: Very favorable. Calculated toner yield is 90% or more.

Good: Favorable. Calculated toner yield is 80% or more and less than 90%.

Not bad: No problem is caused in practical use. The calculated toner yield is 70% or more and less than 80%.

Poor: No good. The calculated toner yield is less than 70%.

[Comprehensive Evaluation]

On the basis of the evaluation results as to the coating uniformity and yield thus far described, the methods for manufacturing a toner of the invention were evaluated comprehensively. The comprehensive evaluation criterion is as follows:

Good: Favorable. Rated as “Excellent” or “Good” in terms of coating uniformity, and rated as “Excellent” or “Good” in terms of yield.

Poor: No good. Rated as “Not bad” or “Poor” in terms of coating uniformity or yield.

The results of evaluation of the toners manufactured by the manufacturing methods of Examples and Comparative Examples are listed in Table 1.

TABLE 1

| | Volume of | | | | | | LEL | | | | | |
|---|---|---|---|---|---|---|---|---|---|---|---|---|
| | Powder | Spray liquid | | | | | concen- | Coating uniformity | | | | Compre- |
| | passage | | | LEL | Supply | Gasification | tration | Residue | | Yield | | hensive |
| | interior | | Molecular | concentration | rate | volume | coeffi- | amount | | Yield | | evalu- |
| | (L) | Kind | weight | (% by volume) | (g/min) | (L/min) | cient | (%) | Evaluation | (%) | Evaluation | ation |
| Ex. 1 | 26.79 | Ethanol | 46.07 | 3.3 | 0.500 | 0.24 | 0.27 | 0 | Excellent | 96 | Excellent | Good |
| Ex. 2 | 3.63 | Ethanol | 46.07 | 3.3 | 0.500 | 0.24 | 2.03 | 0 | Excellent | 93 | Excellent | Good |
| Ex. 3 | 39.66 | Ethanol | 46.07 | 3.3 | 0.500 | 0.24 | 0.19 | 0 | Excellent | 97 | Excellent | Good |
| Ex. 4 | 2.00 | Ethanol | 46.07 | 3.3 | 0.500 | 0.24 | 3.68 | 0 | Excellent | 90 | Excellent | Good |
| Ex. 5 | 26.79 | Ethanol | 46.07 | 3.3 | 0.125 | 0.06 | 0.07 | 0 | Excellent | 96 | Excellent | Good |
| Ex. 6 | 26.79 | Ethanol | 46.07 | 3.3 | 1.000 | 0.49 | 0.55 | 0 | Excellent | 95 | Excellent | Good |
| Ex. 7 | 26.79 | Ethanol | 46.07 | 3.3 | 2.000 | 0.97 | 1.10 | 0 | Excellent | 91 | Excellent | Good |
| Ex. 8 | 26.79 | Ethanol | 46.07 | 3.3 | 2.500 | 1.22 | 1.37 | 0 | Excellent | 87 | Good | Good |
| Ex. 9 | 26.79 | Ethanol | 46.07 | 3.3 | 3.000 | 1.46 | 1.65 | 0 | Excellent | 83 | Good | Good |
| Ex. 10 | 3.63 | Ethanol | 46.07 | 3.3 | 0.125 | 0.06 | 0.51 | 0 | Excellent | 94 | Excellent | Good |
| Ex. 11 | 3.63 | Ethanol | 46.07 | 3.3 | 1.000 | 0.49 | 4.06 | 0 | Excellent | 92 | Excellent | Good |
| Ex. 12 | 3.63 | Ethanol | 46.07 | 3.3 | 2.000 | 0.97 | 8.12 | 0 | Excellent | 86 | Good | Good |
| Ex. 13 | 39.66 | Ethanol | 46.07 | 3.3 | 1.000 | 0.49 | 0.37 | 0 | Excellent | 96 | Excellent | Good |
| Ex. 14 | 39.66 | Ethanol | 46.07 | 3.3 | 2.000 | 0.97 | 0.74 | 0 | Excellent | 92 | Excellent | Good |
| Ex. 15 | 39.66 | Ethanol | 46.07 | 3.3 | 2.500 | 1.22 | 0.93 | 0 | Excellent | 88 | Good | Good |
| Ex. 16 | 39.66 | Ethanol | 46.07 | 3.3 | 3.000 | 1.46 | 1.11 | 0 | Excellent | 85 | Good | Good |
| Ex. 17 | 2.00 | Ethanol | 46.07 | 3.3 | 0.125 | 0.06 | 0.92 | 1 | Good | 92 | Excellent | Good |
| Ex. 18 | 2.00 | Ethanol | 46.07 | 3.3 | 1.000 | 0.49 | 7.37 | 0 | Excellent | 83 | Good | Good |

| | Volume of | | | | | | LEL | | | | | |
|---|---|---|---|---|---|---|---|---|---|---|---|---|
| | Powder | Spray liquid | | | | | concen- | Coating uniformity | | | | Compre- |
| | passage | | | LEL | Supply | Gasification | tration | Residue | | Yield | | hensive |
| | interior | | Molecular | concentration | rate | volume | coeffi- | amount | | Yield | | evalu- |
| | (L) | Kind | weight | (% by volume) | (g/min) | (L/min) | cient | (%) | Evaluation | (%) | Evaluation | ation |
| Comp. | 26.79 | — | — | — | — | — | — | 8 | Not bad | 95 | Excellent | Poor |
| Ex. 1 | | | | | | | | | | | | |
| Comp. | 3.63 | — | — | — | — | — | — | 6 | Not bad | 94 | Excellent | Poor |
| Ex. 2 | | | | | | | | | | | | |
| Comp. | 3.63 | Ethanol | 46.07 | 3.3 | 2.500 | 1.22 | 10.15 | 0 | Excellent | 77 | Not bad | Poor |
| Ex. 3 | | | | | | | | | | | | |
| Comp. | 3.63 | Ethanol | 46.07 | 3.3 | 3.000 | 1.46 | 12.18 | 0 | Excellent | 68 | Poor | Poor |
| Ex. 4 | | | | | | | | | | | | |
| Comp. | 39.66 | — | — | — | — | — | — | 11 | Not bad | 95 | Excellent | Poor |
| Ex. 5 | | | | | | | | | | | | |
| Comp. | 39.66 | Ethanol | 46.07 | 3.3 | 0.125 | 0.06 | 0.05 | 4 | Not bad | 97 | Excellent | Poor |
| Ex. 6 | | | | | | | | | | | | |
| Comp. | 2.00 | — | — | — | — | — | — | 5 | Not bad | 91 | Excellent | Poor |
| Ex. 7 | | | | | | | | | | | | |
| Comp. | 2.00 | Ethanol | 46.07 | 3.3 | 2.000 | 0.97 | 14.73 | 1 | Good | 69 | Poor | Poor |
| Ex. 8 | | | | | | | | | | | | |
| Comp. | 2.00 | Ethanol | 46.07 | 3.3 | 2.500 | 1.22 | 18.42 | 3 | Not bad | 66 | Poor | Poor |
| Ex. 9 | | | | | | | | | | | | |
| Comp. | 2.00 | Ethanol | 46.07 | 3.3 | 3.000 | 1.46 | 22.10 | 4 | Not bad | 59 | Poor | Poor |
| Ex. 10 | | | | | | | | | | | | |
| Comp. | 26.79 | Ethanol | 46.07 | 3.3 | 2.250 | 1.09 | 9.13 | 0 | Excellent | 79 | Not bad | Poor |
| Ex. 11 | | | | | | | | | | | | |

As will be understood from the results listed in Table 1, according to each of Examples 1 through 18 in which ethanol spray treatment has been carried out in such a manner that the LEL concentration coefficient within the powder passage falls in a range of from 0.07 to 8.12, it is possible to obtain a resin-coated toner that is composed of toner base particles whose surfaces are coated with fine resin particles in the form of a uniform film, is free from blocking, and offers good storage stability in a high yield while suppressing development of aggregates.

<Influence of LEL Concentration Coefficient (Spray Liquid: methanol)>

Methanol (molecular weight: 32.04, LEL concentration: 6.7% by volume) was used as the spray liquid. The LEL concentration coefficient within the powder passage was caused to vary by changing the volume of the powder passage interior and the methanol supply rate. In this way, evaluation has been conducted in terms of the influence of the LEL concentration coefficient exerted upon the coating uniformity of the resin coating layer, the yield, and the inclusion of coarse particles.

### Example 19

A toner of Example 19 was obtained in the same manner as in Example 1, except that, in the coating step, methanol (molecular weight: 32.04, LEL concentration: 6.7% by volume) was used instead of ethanol. At this time, the gasification volume and the LEL concentration coefficient within the powder passage were 0.35 L/min and 0.19, respectively.

### Example 20

A toner of Example 20 was obtained in the same manner as in Example 2, except that, in the coating step, methanol (molecular weight: 32.04, LEL concentration: 6.7% by volume) was used instead of ethanol. At this time, the gasification volume and the LEL concentration coefficient within the powder passage were 0.35 L/min and 1.44, respectively.

### Example 21

A toner of Example 21 was obtained in the same manner as in Example 3, except that, in the coating step, methanol (molecular weight: 32.04, LEL concentration: 6.7% by volume) was used instead of ethanol. At this time, the gasification volume and the LEL concentration coefficient within the powder passage were 0.35 L/min and 0.13, respectively.

### Example 22

A toner of Example 22 was obtained in the same manner as in Example 4, except that, in the coating step, methanol (molecular weight: 32.04, LEL concentration: 6.7% by volume) was used instead of ethanol. At this time, the gasification volume and the LEL concentration coefficient within the powder passage were 0.35 L/min and 2.61, respectively.

### Example 23

A toner of Example 23 was obtained in the same manner as in Example 19, except that, in the coating step, the methanol supply rate was changed from 0.500 g/min to 1.000 g/min. At this time, the gasification volume and the LEL concentration coefficient within the powder passage were 0.70 L/min and 0.39, respectively.

### Example 24

A toner of Example 24 was obtained in the same manner as in Example 19, except that, in the coating step, the methanol supply rate was changed from 0.500 g/min to 2.000 g/min. At this time, the gasification volume and the LEL concentration coefficient within the powder passage were 1.40 L/min and 0.78, respectively.

### Example 25

A toner of Example 25 was obtained in the same manner as in Example 19, except that, in the coating step, the methanol supply rate was changed from 0.500 g/min to 2.500 g/min. At this time, the gasification volume and the LEL concentration coefficient within the powder passage were 1.75 L/min and 0.97, respectively.

### Example 26

A toner of Example 26 was obtained in the same manner as in Example 19, except that, in the coating step, the methanol supply rate was changed from 0.500 g/min to 3.000 g/min. At this time, the gasification volume and the LEL concentration coefficient within the powder passage were 2.10 L/min and 1.17, respectively.

### Example 27

A toner of Example 27 was obtained in the same manner as in Example 20, except that, in the coating step, the methanol supply rate was changed from 0.500 g/min to 0.125 g/min. At this time, the gasification volume and the LEL concentration coefficient within the powder passage were 0.09 L/min and 0.36, respectively.

### Example 28

A toner of Example 28 was obtained in the same manner as in Example 20, except that, in the coating step, the methanol supply rate was changed from 0.500 g/min to 1.000 g/min. At this time, the gasification volume and the LEL concentration coefficient within the powder passage were 0.70 L/min and 2.87, respectively.

### Example 29

A toner of Example 29 was obtained in the same manner as in Example 20, except that, in the coating step, the methanol supply rate was changed from 0.500 g/min to 2.000 g/min. At this time, the gasification volume and the LEL concentration coefficient within the powder passage were 1.40 L/min and 5.75, respectively.

### Example 30

A toner of Example 30 was obtained in the same manner as in Example 20, except that, in the coating step, the methanol supply rate was changed from 0.500 g/min to 2.500 g/min. At this time, the gasification volume and the LEL concentration coefficient within the powder passage were 1.75 L/min and 7.19, respectively.

### Example 31

A toner of Example 31 was obtained in the same manner as in Example 21, except that, in the coating step, the methanol supply rate was changed from 0.500 g/min to 1.000 g/min. At this time, the gasification volume and the LEL concentration coefficient within the powder passage were 0.70 L/min and 0.26, respectively.

### Example 32

A toner of Example 32 was obtained in the same manner as in Example 21, except that, in the coating step, the methanol supply rate was changed from 0.500 g/min to 2.000 g/min. At this time, the gasification volume and the LEL concentration coefficient within the powder passage were 1.40 L/min and 0.53, respectively.

### Example 33

A toner of Example 33 was obtained in the same manner as in Example 21, except that, in the coating step, the methanol supply rate was changed from 0.500 g/min to 2.500 g/min. At this time, the gasification volume and the LEL concentration coefficient within the powder passage were 1.75 L/min and 0.66, respectively.

### Example 34

A toner of Example 34 was obtained in the same manner as in Example 21, except that, in the coating step, the methanol supply rate was changed from 0.500 g/min to 3.000 g/min. At this time, the gasification volume and the LEL concentration coefficient within the powder passage were 2.10 L/min and 0.79, respectively.

### Example 35

A toner of Example 35 was obtained in the same manner as in Example 22, except that, in the coating step, the methanol supply rate was changed from 0.500 g/min to 0.125 g/min. At this time, the gasification volume and the LEL concentration coefficient within the powder passage were 0.09 L/min and 0.65, respectively.

### Example 36

A toner of Example 36 was obtained in the same manner as in Example 22, except that, in the coating step, the methanol supply rate was changed from 0.500 g/min to 1.000 g/min. At this time, the gasification volume and the LEL concentration coefficient within the powder passage were 0.70 L/min and 5.22, respectively.

### Comparative Example 12

A toner of Comparative example 12 was obtained in the same manner as in Example 19, except that, in the coating step, the methanol supply rate was changed from 0.500 g/min to 0.125 g/min. At this time, the gasification volume and the LEL concentration coefficient within the powder passage were 0.09 L/min and 0.05, respectively.

### Comparative Example 13

A toner of Comparative example 13 was obtained in the same manner as in Example 20, except that, in the coating step, the methanol supply rate was changed from 0.500 g/min to 3.000 g/min. At this time, the gasification volume and the LEL concentration coefficient within the powder passage were 2.10 L/min and 8.62, respectively.

### Comparative Example 14

A toner of Comparative example 14 was obtained in the same manner as in Example 21, except that, in the coating step, the methanol supply rate was changed from 0.500 g/min to 0.125 g/min. At this time, the gasification volume and the LEL concentration coefficient within the powder passage were 0.09 L/min and 0.03, respectively.

### Comparative Example 15

A toner of Comparative example 15 was obtained in the same manner as in Example 22, except that, in the coating step, the methanol supply rate was changed from 0.500 g/min to 2.000 g/min. At this time, the gasification volume and the LEL concentration coefficient within the powder passage were 1.40 L/min and 10.43, respectively.

### Comparative Example 16

A toner of Comparative example 16 was obtained in the same manner as in Example 22, except that, in the coating step, the methanol supply rate was changed from 0.500 g/min to 2.500 g/min. At this time, the gasification volume and the LEL concentration coefficient within the powder passage were 1.75 L/min and 13.04, respectively.

### Comparative Example 17

A toner of Comparative example 17 was obtained in the same manner as in Example 22, except that, in the coating step, the methanol supply rate was changed from 0.500 g/min to 3.000 g/min. At this time, the gasification volume and the LEL concentration coefficient within the powder passage were 2.10 L/min and 15.65, respectively.

The toners of Examples 19 through 36 and Comparative Examples 11 through 16 thereby obtained have been evaluated in terms of the coating uniformity and the yield described above. The results of evaluation are listed in Table 2.

TABLE 2

| | Volume of | | | | | | LEL | | | | | |
|---|---|---|---|---|---|---|---|---|---|---|---|---|
| | Powder | Spray liquid | | | | | concen- | Coating uniformity | | | | Compre- |
| | passage | | | LEL | Supply | Gasification | tration | Residue | | Yield | | hensive |
| | interior | | Molecular | concentration | rate | volume | coeffi- | amount | | Yield | | evalu- |
| | (L) | Kind | weight | (% by volume) | (g/min) | (L/min) | cient | (%) | Evaluation | (%) | Evaluation | ation |
| Ex. 19 | 26.79 | Methanol | 32.04 | 6.7 | 0.500 | 0.35 | 0.19 | 0 | Excellent | 95 | Excellent | Good |
| Ex. 20 | 3.63 | Methanol | 32.04 | 6.7 | 0.500 | 0.35 | 1.44 | 0 | Excellent | 93 | Excellent | Good |
| Ex. 21 | 39.66 | Methanol | 32.04 | 6.7 | 0.500 | 0.35 | 0.13 | 0 | Excellent | 96 | Excellent | Good |
| Ex. 22 | 2.00 | Methanol | 32.04 | 6.7 | 0.500 | 0.35 | 2.61 | 1 | Good | 90 | Excellent | Good |
| Ex. 23 | 26.79 | Methanol | 32.04 | 6.7 | 1.000 | 0.70 | 0.39 | 0 | Excellent | 93 | Excellent | Good |
| Ex. 24 | 26.79 | Methanol | 32.04 | 6.7 | 2.000 | 1.40 | 0.78 | 0 | Excellent | 91 | Excellent | Good |
| Ex. 25 | 26.79 | Methanol | 32.04 | 6.7 | 2.500 | 1.75 | 0.97 | 0 | Excellent | 87 | Good | Good |
| Ex. 26 | 26.79 | Methanol | 32.04 | 6.7 | 3.000 | 2.10 | 1.17 | 0 | Excellent | 83 | Good | Good |
| Ex. 27 | 3.63 | Methanol | 32.04 | 6.7 | 0.125 | 0.09 | 0.36 | 0 | Excellent | 92 | Excellent | Good |
| Ex. 28 | 3.63 | Methanol | 32.04 | 6.7 | 1.000 | 0.70 | 2.87 | 0 | Excellent | 91 | Excellent | Good |
| Ex. 29 | 3.63 | Methanol | 32.04 | 6.7 | 2.000 | 1.40 | 5.75 | 0 | Excellent | 90 | Excellent | Good |
| Ex. 30 | 3.63 | Methanol | 32.04 | 6.7 | 2.500 | 1.75 | 7.19 | 0 | Excellent | 81 | Good | Good |
| Ex. 31 | 39.66 | Methanol | 32.04 | 6.7 | 1.000 | 0.70 | 0.26 | 0 | Excellent | 95 | Excellent | Good |
| Ex. 32 | 39.66 | Methanol | 32.04 | 6.7 | 2.000 | 1.40 | 0.53 | 0 | Excellent | 94 | Excellent | Good |
| Ex. 33 | 39.66 | Methanol | 32.04 | 6.7 | 2.500 | 1.75 | 0.66 | 0 | Excellent | 92 | Excellent | Good |
| Ex. 34 | 39.66 | Methanol | 32.04 | 6.7 | 3.000 | 2.10 | 0.79 | 0 | Excellent | 90 | Excellent | Good |
| Ex. 35 | 2.00 | Methanol | 32.04 | 6.7 | 0.125 | 0.09 | 0.65 | 2 | Good | 90 | Excellent | Good |
| Ex. 36 | 2.00 | Methanol | 32.04 | 6.7 | 1.000 | 0.70 | 5.22 | 1 | Good | 82 | Good | Good |
| Comp. | 26.79 | Methanol | 32.04 | 6.7 | 0.125 | 0.09 | 0.05 | 6 | Not bad | 94 | Excellent | Poor |
| Ex. 12 | | | | | | | | | | | | |
| Comp. | 3.63 | Methanol | 32.04 | 6.7 | 3.000 | 2.10 | 8.62 | 0 | Excellent | 68 | Poor | Poor |
| Ex. 13 | | | | | | | | | | | | |
| Comp. | 39.66 | Methanol | 32.04 | 6.7 | 0.125 | 0.09 | 0.03 | 11 | Not bad | 96 | Excellent | Poor |
| Ex. 14 | | | | | | | | | | | | |
| Comp. | 2.00 | Methanol | 32.04 | 6.7 | 2.000 | 1.40 | 10.43 | 4 | Not bad | 76 | Not bad | Poor |
| Ex. 15 | | | | | | | | | | | | |
| Comp. | 2.00 | Methanol | 32.04 | 6.7 | 2.500 | 1.75 | 13.04 | 5 | Not bad | 68 | Poor | Poor |
| Ex. 16 | | | | | | | | | | | | |
| Como. | 2.00 | Methanol | 32.04 | 6.7 | 3.000 | 2.10 | 15.65 | 7 | Not bad | 65 | Poor | Poor |
| Ex. 17 | | | | | | | | | | | | |

As will be understood from the results listed in Table 2, according to each of Examples 19 through 36 in which methanol spray treatment has been carried out in such a manner that the LEL concentration coefficient within the powder passage falls in a range of from 0.07 to 8.12, even if methanol was used as the spray liquid instead of ethanol, just as in the case of Examples 1 through 18 in which ethanol was used as the spray liquid, it is possible to obtain a resin-coated toner that is composed of toner base particles whose surfaces are coated with fine resin particles in the form of a uniform film, is free from blocking, and offers good storage stability in a high yield while suppressing development of aggregates.

<Evaluation for the Case of Using Liquid Mixture as Spray Liquid>

Evaluation has been conducted in terms of the coating uniformity of the resin coating layer, the yield, and the inclusion of coarse particles as seen in the case of using a liquid of ethanol-methanol mixture as the spray liquid.

### Example 37

A toner of Example 37 was obtained in the same manner as in Example 1, except that, in the coating step, an ethanol-methanol mixture liquid (ethanol: 30% by volume, methanol: 70% by volume) was used as the spray liquid, and the ethanol supply rate was set at 0.190 g/min and the methanol supply rate was set at 0.310 g/min. At this time, the LEL concentration of the liquid mixture was 5.1% by volume. Moreover, within the powder passage, the gasification volume of ethanol was 0.09 L/min, the gasification volume of methanol was 0.22 L/min, and the LEL concentration coefficient was 0.23.

### Example 38

A toner of Example 38 was obtained in the same manner as in Example 1, except that, in the coating step, an ethanol-methanol mixture liquid (ethanol: 50% by volume, methanol: 50% by volume) was used as the spray liquid, and the ethanol supply rate was set at 0.300 g/min and the methanol supply rate was set at 0.210 g/min. At this time, the LEL concentration of the liquid mixture was 4.4% by volume. Moreover, within the powder passage, the gasification volume of ethanol was 0.15 L/min, the gasification volume of methanol was 0.15 L/min, and the LEL concentration coefficient was 0.25.

### Example 39

A toner of Example 39 was obtained in the same manner as in Example 1, except that, in the coating step, an ethanol-methanol mixture liquid (ethanol: 70% by volume, methanol: 30% by volume) was used as the spray liquid, and the ethanol supply rate was set at 0.380 g/min and the methanol supply rate was set at 0.120 g/min. At this time, the LEL concentration of the liquid mixture was 3.9% by volume. Moreover, within the powder passage, the gasification volume of ethanol was 0.18 L/min, the gasification volume of methanol was 0.08 L/min, and the LEL concentration coefficient was 0.26.

The toners of Examples 37 through 39 thereby obtained have been evaluated in terms of, in addition to the foregoing coating uniformity and yield, inclusion of coarse particles. The results of evaluation are listed in Table 3.

[Inclusion of Coarse Particles]

With use of the toners of Examples and Comparative Examples, evaluation has been conducted in terms of the percentage of coarse particles included that are 12 μm or above in size in the following manner involving particle size distribution measurement.

To 50 ml of an electrolysis solution (trade name: ISOTON-II, manufactured by Beckman Coulter, Inc.), 20 mg of a toner sample and 1 ml of sodium alkyl ether sulfate were added. The resultant admixture was subjected to 3-minute dispersion treatment at an ultrasonic frequency of 20 kHz in an ultrasonic disperser (trade name: ULTRASONIC CLEANER (tabletop dual-frequency ultrasonic cleaner) Type VS-D100, manufactured by AS ONE Corporation) thereby to prepare a test sample for measurement. Then, under conditions of an aperture diameter of 100 μm and the number of particles to be measured is 50000 counts, measurement was carried out on the test sample for measurement by means of a particle size distribution measuring apparatus (trade name: Multisizer III, manufactured by Beckman Coulter, Inc.). On the basis of the measured volumetric particle size distribution of the sample particles, the percentage of particles of a size of 12 μm or above was determined as the percentage of coarse-particle inclusion for evaluation. Note that, the smaller is the percentage of coarse-particle inclusion, the less likely it is that mutual aggregation among toner particles occurs during test toner production; that is, the better the toner characteristics.

The evaluation criterion is as follows:

Excellent: Very favorable. The percentage of coarse-particle inclusion is less than 1%.

Good: Favorable. The percentage of coarse-particle inclusion is greater than or equal to 1% but less than 3%.

Not bad: No problem is caused in practical use. The percentage of coarse-particle inclusion is greater than or equal to 3% but less than 10%.

Poor: No good. The percentage of coarse-particle inclusion is greater than 10%.

TABLE 3

| | | Spray liquid | | | | | | | | |
|---|---|---|---|---|---|---|---|---|---|---|
| | Volume of | | | | | | | | LEL | LEL |
| | Powder | | | | | | | | concentration | concen- |
| | passage | | | LEL | Supply | Gasification | Mixing ratio of liquid mixture | | of liquid | tration |
| | interior | | Molecular | concentration | rate | volume | Volume percent | Weight percent | mixture | coeffi- |
| | (L) | Kind | weight | (% by volume) | (g/min) | (L/min) | (% by volume) | (% by weight) | (% by volume) | cient |
| Ex. 37 | 26.79 | Ethanol | 46.07 | 3.3 | 0.190 | 0.09 | 30 | 38 | 5.1 | 0.23 |
| | | Methanol | 32.04 | 6.7 | 0.310 | 0.22 | 70 | 62 | | |
| Ex. 38 | 26.79 | Ethanol | 46.07 | 3.3 | 0.300 | 0.15 | 50 | 59 | 4.4 | 0.25 |
| | | Methanol | 32.04 | 6.7 | 0.210 | 0.15 | 50 | 41 | | |
| Ex. 39 | 26.79 | Ethanol | 46.07 | 3.3 | 0.380 | 0.18 | 70 | 77 | 3.9 | 0.26 |
| | | Methanol | 32.04 | 6.7 | 0.120 | 0.08 | 30 | 23 | | |

| | Coating uniformity | | Yield | | Inclusion of coarse particles | | Comprehensive |
|---|---|---|---|---|---|---|---|
| | Residue amount (%) | Evaluation | Yield (%) | Evaluation | Percentage of inclusion (%) | Evaluation | evaluation |
| Ex. 37 | 0 | Excellent | 95 | Excellent | 1.1 | Good | Good |
| Ex. 38 | 0 | Excellent | 95 | Excellent | 1.0 | Good | Good |
| Ex. 39 | 0 | Excellent | 96 | Excellent | 1.0 | Good | Good |

As will be understood from the results listed in Table 3, according to each of Examples 37 through 39 in which liquid mixture spray treatment has been carried out in such a manner that the LEL concentration coefficient within the powder passage falls in a range of from 0.07 to 8.12, even in the case of using the ethanol-Methanol mixture liquid as the spray liquid, it is possible to obtain a resin-coated toner that is composed of toner base particles whose surfaces are coated with fine resin particles in the form of a uniform film, is free from blocking, and offers good storage stability in a high yield while suppressing development of aggregates.

<Evaluation for the Case of Changing the Kind of Spray Liquid>

Evaluation has been conducted in terms of the coating uniformity of the resin coating layer, the yield, and the inclusion of coarse particles as seen in the case of changing the kind of the spray liquid.

### Example 40

A toner of Example 40 was obtained in the same manner as in Example 1, except that, in the coating step, 2-propanol (molecular weight: 60.10, LEL concentration: 2.0% by volume) was used instead of ethanol. At this time, the gasification volume and the LEL concentration coefficient within the powder passage were 0.19 L/min and 0.35, respectively.

### Example 41

A toner of Example 41 was obtained in the same manner as in Example 1, except that, in the coating step, 2-butanol (molecular weight: 74.12, LEL concentration: 1.7% by volume) was used instead of ethanol. At this time, the gasification volume and the LEL concentration coefficient within the powder passage were 0.15 L/min and 0.33, respectively.

### Example 42

A toner of Example 42 was obtained in the same manner as in Example 1, except that, in the coating step, 1-butanol (molecular weight: 74.12, LEL concentration: 1.4% by volume) was used instead of ethanol. At this time, the gasification volume and the LEL concentration coefficient within the powder passage were 0.15 L/min and 0.40, respectively.

The toners of Examples 40 through 42 thereby obtained have been evaluated in terms of the foregoing coating uniformity, yield, and inclusion of coarse particles. The results of evaluation are listed in Table 4.

TABLE 4

| | Volume of Powder | Spray liquid | | | | | |
|---|---|---|---|---|---|---|---|
| | passage inferior | | | LEL concentration | Supply rate | Gasification volume | LEL concentration |
| | (L) | Kind | Molecular weight | (% by volume) | (g/min) | (L/min] | coefficient |
| Ex. 1 | 26.79 | Ethanol | 46.07 | 3.3 | 0.500 | 0.24 | 0.27 |
| Ex. 19 | 26.79 | Methanol | 32.04 | 6.7 | 0.500 | 0.35 | 0.19 |
| Ex. 40 | 26.79 | Propanol | 60.10 | 2.0 | 0.500 | 0.19 | 0.35 |
| Ex. 41 | 26.79 | 2-butanol | 74.12 | 1.7 | 0.500 | 0.15 | 0.33 |
| Ex. 42 | 26.79 | 1-butanol | 74.12 | 1.4 | 0.500 | 0.15 | 0.40 |

| | Coating uniformity | | Yield | | Inclusion of coarse particles | | Comprehensive |
|---|---|---|---|---|---|---|---|
| | Residue amount (%) | Evaluation | Yield (%) | Evaluation | Percentage of inclusion (%) | Evaluation | evaluation |
| Ex. 1 | 0 | Excellent | 96 | Excellent | 0.8 | Excellent | Good |
| Ex. 19 | 0 | Excellent | 95 | Excellent | 1.2 | Good | Good |
| Ex. 40 | 0 | Excellent | 89 | Good | 1.6 | Good | Good |
| Ex. 41 | 0 | Excellent | 83 | Good | 2.7 | Good | Good |
| Ex. 42 | 0 | Excellent | 80 | Good | 3.1 | Not bad | Good |

As will be understood from the results listed in Table 4, according to each of Examples 40 through 42 in which an alcohol ranging in LEL concentration from 1.4% to 6.7% by volume was used as the spray liquid, it is possible to obtain a resin-coated toner that is composed of toner base particles whose surfaces are coated with fine resin particles in the form of a uniform film, is free from blocking, and offers good storage stability in a high yield while suppressing development of aggregates.

It will also be understood that, from the standpoint of producing a desired toner in a high yield while suppressing development of aggregates, Examples 1, 19, and 40 that employ ethanol, methanol, and propanol, respectively, that are each a low-grade alcohol in which a number of carbon in a molecule is 3 or below have the advantage over Examples 41 and 42 that employ butanol which is a low-grade alcohol in which a number of carbon in a molecule is 4.

<Evaluation for the Case of Changing Air Discharge Amount>

Evaluation has been conducted in terms of the coating uniformity of the resin coating layer, the yield, and the inclusion of coarse particles as seen in the case of changing the amount of air discharge in the coating step.

### Example 43

A toner of Example 43 was obtained in the same manner as in Example 9, except that, in the coating step, the amount of air discharge was set at 15 L/min under conditions where the supply of air from the two-fluid nozzle is 5 L/min and the supply of air which is admitted via the rotary shaft into the apparatus is adjusted to 10 L/min, so that the total sum of air supply is 15 L/min.

### Example 44

A toner of Example 44 was obtained in the same manner as in Example 9, except that, in the coating step, the amount of air discharge was set at 30 L/min under conditions where the supply of air from the two-fluid nozzle is 5 L/min and the supply of air which is admitted via the rotary shaft into the apparatus is adjusted to 25 L/min, so that the total sum of air supply is 30 L/min.

### Example 45

A toner of Example 45 was obtained in the same manner as in Example 9, except that, in the coating step, the amount of air discharge was set at 50 L/min under conditions where the supply of air from the two-fluid nozzle is 5 L/min and the supply of air which is admitted via the rotary shaft into the apparatus is adjusted to 45 L/min, so that the total sum of air supply is 50 L/min.

### Example 46

A toner of Example 46 was obtained in the same manner as in Example 9, except that, in the coating step, the amount of air discharge was set at 7.5 L/min under conditions where the supply of air from the two-fluid nozzle is 5 L/min and the supply of air which is admitted via the rotary shaft into the apparatus is adjusted to 2.5 L/min, so that the total sum of air supply is 7.5 L/min.

### Example 47

A toner of Example 47 was obtained in the same manner as in Example 9, except that, in the coating step, the amount of air discharge was set at 70 L/min under conditions where the supply of air from the two-fluid nozzle is 5 L/min and the supply of air which is admitted via the rotary shaft into the apparatus is adjusted to 65 L/min, so that the total sum of air supply is 70 L/min.

The toners of Examples 43 through 47 thereby obtained have been evaluated in terms of the foregoing coating uniformity and yield. The results of evaluation are listed in Table 5.

TABLE 5

| | Volume of Powder | Spray liquid | | | | | |
|---|---|---|---|---|---|---|---|
| | passage interior | | | LEL concentration | Supply rate | Gasification volume | LEL concentration |
| | (L) | Kind | Molecular weight | (% by volume) | (g/min) | (L/min) | coefficient |
| Ex. 9 | 26.79 | Ethanol | 46.07 | 3.3 | 3.000 | 1.46 | 1.65 |
| Ex. 43 | 26.79 | Ethanol | 46.07 | 3.3 | 3.000 | 1.46 | 1.65 |
| Ex. 44 | 26.79 | Ethanol | 46.07 | 3.3 | 3.000 | 1.46 | 1.65 |
| Ex. 45 | 26.79 | Ethanol | 46.07 | 3.3 | 3.000 | 1.46 | 1.65 |
| Ex. 46 | 26.79 | Ethanol | 46.07 | 3.3 | 3.000 | 1.46 | 1.65 |
| Ex. 47 | 26.79 | Ethanol | 46.07 | 3.3 | 3.000 | 1.46 | 1.65 |

| | Air supply from nozzle | Air discharge amount | Coating uniformity | | Yield | | Comprehensive |
|---|---|---|---|---|---|---|---|
| | (L/min) | (L/min) | Residue amount (%) | Evaluation | Yield (%) | Evaluation | evaluation |
| Ex. 9 | 5 | 10 | 0 | Excellent | 83 | Good | Good |
| Ex. 43 | 5 | 15 | 0 | Excellent | 89 | Good | Good |
| Ex. 44 | 5 | 30 | 0 | Excellent | 91 | Excellent | Good |
| Ex. 45 | 5 | 50 | 0 | Excellent | 88 | Good | Good |
| Ex. 46 | 5 | 7.5 | 0 | Excellent | 80 | Good | Good |
| Ex. 47 | 5 | 70 | 0 | Excellent | 81 | Good | Good |

As will be understood from the results listed in Table 5, by adjusting the amount of air to be discharged out of the powder passage to fall in a range of from 10 to 70 L/min, it is possible to obtain a resin-coated toner that is composed of toner base particles whose surfaces are coated with fine resin particles in the form of a uniform film, is free from blocking, and offers good storage stability in a high yield while suppressing development of aggregates.

<Preparation of Color Toner Base Particles>

In the toner base particle preparation step S1 (cyan toner base particle preparation step) described above, magenta toner base particles and yellow toner base particles were prepared in the same manner as in the preparation of cyan toner base particles, except for toner composition as set forth hereunder.

(Composition Set for Magenta Toner Base Particle Preparation)

| | | |
|---|---|---|
| Polyester resin (trade name: DIACRON, manufactured by | 87.5% | (100 parts) |
| Mitsubishi Rayon Co., Ltd.) having a glass transition | | |
| temperature of 55° C. and a softening temperature of 130° C.: | | |
| C.I. Pigment Red 122 (Toner Magenta E-02, manufactured | 5.0% | (5.7 parts) |
| by Clariant Japan): | | |
| Release agent (carnauba wax having a melting point of | 6.0% | (6.9 parts) |
| 82° C.): | | |
| Charge control agent (trade name: BONTRON E84, | 1.5% | (1.7 parts) |
| manufactured by Orient Chemical Industries, Ltd.): | | |

(Composition set for yellow toner base particle preparation)

| | | |
|---|---|---|
| Polyester resin (trade name: DIACRON, manufactured by | 87.5% | (100 parts) |
| Mitsubishi Rayon Co., Ltd.) having a glass transition | | |
| temperature of 55° C. and a softening temperature of 130° C.: | | |
| C.I. Pigment Yellow 74 (FAST YELLOW FGOK, manufactured | 5.0% | (5.7 parts) |
| by Sanyo Color Works, LTD.): | | |
| Release agent (carnauba wax having a melting point of | 6.0% | (6.9 parts) |
| 82° C.): | | |
| Charge control agent (trade name: BONTRON E84, | 1.5% | (1.7 parts) |
| manufactured by Orient Chemical Industries, Ltd.): | | |

<Preparation of Two-Component Developer>

### Example 48

To 100 parts of the toner of Example 5 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Example 5, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Example 5, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Example 49

To 100 parts of the toner of Example 1 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Example 1, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was formed.

Further, a yellow toner was manufactured in the same manner as in Example 1, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Example 50

To 100 parts of the toner of Example 6 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Example 6, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Example 6, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Example 51

To 100 parts of the toner of Example 7 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Example 7, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Example 7, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Example 52

To 100 parts of the toner of Example 2 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%, In this way, a cyan two-component developer was prepared.

Moreover, a magenta toner was manufactured in the same manner as in Example 2, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Example 2, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Example 53

To 100 parts of the toner of Example 12 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Example 12, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Example 12, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Comparative Example 18

To 100 parts of the toner of Comparative Example 6 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Comparative Example 6, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Comparative Example 6, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Comparative Example 19

To 100 parts of the toner of Comparative Example 3 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Comparative Example 3, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Comparative Example 3, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Comparative Example 20

To 100 parts of the toner of Comparative Example 1 described above, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, a magenta toner was manufactured in the same manner as in Comparative Example 1, except that the foregoing magenta toner base particles were used instead of the cyan toner base particles. The magenta toner was subjected to external addition of external additives in a like manner to obtain a magenta toner in which external additives were externally added. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, a yellow toner was manufactured in the same manner as in Comparative Example 1, except that the foregoing yellow toner base particles were used instead of the cyan toner base particles. The yellow toner was subjected to external addition of external additives in a like manner to obtain a yellow toner in which external additives were externally added. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

### Comparative Example 21

To 100 parts of the foregoing cyan toner base particles, as external additives, 1.3 parts of fine hydrophobic silica particles having an average primary particle size of 12 nm, 0.5 parts of fine hydrophobic silica particles having an average primary particle size of 200 nm, and 0.6 parts of hydrophobic titanium oxide having an average primary particle size of 30 nm were added. The resultant admixture was subjected to 3-minute mixing process, with the circumferential velocity of the rotary member set at 35 m/s, by means of a Henschel mixer (trade name: Type FM 20C, manufactured by Mitsui Mining Co., Ltd.) thereby to obtain a cyan toner in which external additives were externally added. Then, the externally-added cyan toner thereby obtained and a silicone-coated ferrite core carrier having a volume average particle size of 60 μm have been blended with each other so as to adjust the toner density to 5%. In this way, a cyan two-component developer was prepared.

Moreover, with use of the foregoing magenta toner base particles, a magenta toner in which external additives were externally added was obtained in a like manner. Then, the externally-added magenta toner thereby obtained and a silicone-coated ferrite core carrier having a volume average particle size of 60 μm have been blended with each other so as to adjust the toner density to 5%. In this way, a magenta two-component developer was prepared.

Further, with use of the foregoing yellow toner base particles, a yellow toner in which external additives were externally added was obtained in a like manner. Then, the externally-added yellow toner thereby obtained and a silicone-coated ferrite core carrier having a volume average particle size of 60 μm have been blended with each other so as to adjust the toner density to 5%. In this way, a yellow two-component developer was prepared.

That is, according to Comparative Example 21, the two-component developers of different colors were each prepared by using a toner having no resin coating layer formed on the surface thereof.

<Image Formation Performance Evaluation>

Each of the thereby prepared two-component developers of Examples 48 through 53 and Comparative Examples 18 through 21 was charged in a copying machine equipped with a commercially available two-component developer-based developing device (trade name: type MX-2300G, manufactured by SHARP CORPORATION) to effect image formation. Evaluation has been conducted in terms of the following points.

[Cleanability]

Following the completion of consecutive production of 1000 sheets of copies bearing a chart with a coverage rate of 5%, the presence or absence of a filming phenomenon on the photoreceptor surface was checked by visual examination. The cleanability evaluation criterion is as follows:

Good: Favorable. None of the developers of different colors caused filming.

Not so good: Less than favorable. Only one of the developers of different colors caused filming.

Poor: No good. Two or more of the developers of different colors caused filming.

[Charge-Amount Stability]

Charge-amount stability evaluation has been conducted by measuring the amount of charge following the completion of the aforestated chart printing. A charge amount comparison was made among the toners of different colors with respect to each Example to determine a difference ΔQc (μC/g) between a minimum and a maximum in the amount of charge. The evaluation has been conducted on the basis of the difference μQc. The charge-amount stability evaluation criterion is as follows:

Good: Favorable. 5≧|ΔQc|.

Not bad: No problem is caused in practical use. |ΔQc|>5.

Poor: No good. |ΔQc|>7.

[Density Uniformity]

Next, after intensive production of 10000 sheets of copies has been gone through with, unevenness of density was measured in the following manner. 5 pieces of circumferentially continuous patches were printed equidistantly, and the image densities ID thereof were measured by means of X-Rite to determine a difference ΔID between a maximum and a minimum in density for the patches of identical color. The density uniformity evaluation has been conducted on the basis of the difference ΔID. Note that, from among the differences ΔID of the patches of different colors, the largest one was selected for the evaluation. The density uniformity evaluation criterion is as follows:

Good: Favorable. 0.2≧|ID|.

Not bad: No problem is caused in practical use. 0.3≧|ΔID|>0.2.

Poor: No good. |ΔID|>0.3.

[Comprehensive Evaluation]

On the basis of the evaluation results in terms of cleanability, charge-amount stability, and density uniformity thus far described, comprehensive evaluation was conducted for the case of using the toners of the invention.

The comprehensive evaluation criterion is as follows:

Good: Favorable. Rated as “Good” for all of the cleanability, the charge-amount stability, and the density uniformity.

Poor: No good. Rated as “Not bad” (Not so good) or “Poor” for any of the cleanability, the charge-amount stability, and the density uniformity.

Table 6 shows the results of evaluation in terms of cleanability, charge-amount stability, and density uniformity for the case of effecting image formation with use of the two-component developers of Examples 48 through 53 and Comparative Examples 18 through 21.

TABLE 6

| | LEL concentration | | | | |
|---|---|---|---|---|---|
| | coefficient at pro- | | Charge- | | |
| | duction of different- | | amount | Density | Comprehensive |
| | color toners | Cleanability | stability | uniformity | evaluation |
| Ex. 48 | 0.07 | Good | Good | Good | Good |
| Ex. 49 | 0.27 | Good | Good | Good | Good |
| Ex. 50 | 0.55 | Good | Good | Good | Good |
| Ex. 51 | 1.10 | Good | Good | Good | Good |
| Ex. 52 | 2.03 | Good | Good | Good | Good |
| Ex. 53 | 8.12 | Good | Good | Good | Good |
| Comp. Ex. 18 | 0.05 | Poor | Good | Not bad | Poor |
| Comp. Ex. 19 | 10.15 | Good | Good | Not bad | Poor |
| Comp. Ex. 20 | — | Poor | Good | Not bad | Poor |
| Comp. Ex. 21 | — | Not so good | Poor | Poor | Poor |

As will be understood from the results listed in Table 6, in the case of effecting image formation by using any of the developers of Examples 48 through 53, i.e. the two-component developers containing the toner of the invention that is free from blocking and offers excellent storage stability, it is possible to form high-quality images that are free from unevenness in density and are thus uniform in density while achieving satisfactory cleanability and charge amount stability.

The invention may be embodied in other specific forms without departing from the spirit or essential characteristics thereof. The embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A method for manufacturing a toner comprising:
a fine resin particle adhering step of putting toner base particles and fine resin particles into a powder passage with a rotary stirring section in a rotating state, so that the fine resin particles adhere to the surfaces of the toner base particles;
a spraying step of spraying the toner base particles and the fine resin particles in a fluidized state with a substance in liquid form capable of plasticizing those particles in the presence of a carrier gas by means of a spraying section; and
a film-forming step of rotating the rotary stirring section continuously to circulate the toner base particles and the fine resin particles repeatedly within the powder passage until the fine resin particles adherent to the toner base particles are changed to a film state,
the spraying section squirting the substance in liquid form in the spraying step in such a manner that an LEL concentration coefficient X within the powder passage fulfills the following formula (1):
0.07≦X≦8.12 (1)
wherein
the LEL concentration coefficient X is represented in expression form as follows:
X={(Gasification volume of substance in liquid form to be sprayed per unit of time)/(Powder passage interior volume)}×100/(LEL concentration of substance in liquid form), the substance-in-liquid-form LEL concentration being indicative of a lower explosive limit concentration of the substance in liquid form in a gasified state under predetermined conditions.

2. The method of claim 1, wherein the toner manufacturing is performed by using a rotary stirring device comprising: a circulation section for effecting repeated circulation of the toner base particles and the fine resin particles within the powder passage including a rotary stirring chamber and a circulating tube and return of those particles to the rotary stirring chamber by means of a rotary stirring section including a rotary disc with rotating vanes installed therearound and a rotary shaft; a temperature regulation section provided in at least a part of the powder passage, for regulating the temperatures of the interior of the powder passage and the rotary stirring section to predetermined temperatures; and a spraying section, and
in the fine resin particle adhering step, the spraying step, and the film-forming step, the temperatures of the interior of the powder passage and the rotary stirring section are regulated to the predetermined temperatures by the temperature regulation section.

3. The method of claim 1, wherein the substance in liquid form which is sprayed in the spraying step is an alcohol having an LEL concentration in a range of from 1.4% to 6.7% by volume.

4. The method of claim 3, wherein the substance in liquid form is a low-grade alcohol in which a number of carbon in a molecule is 3 or below.

5. A toner manufactured by the method for manufacturing a toner of claim 1.

6. A developer comprising the toner of claim 5.

7. The developer of claim 6, further comprising a carrier, the developer constituting a two-component developer.

8. A developing device that develops a latent image formed on an image bearing member to form a toner image using the developer of claim 6.

9. A developing device that develops a latent image formed on an image bearing member to form a toner image using the developer of claim 7.

10. An image forming apparatus, comprising:
an image bearing member on which a latent image is to be formed;
a latent image forming section for forming the latent image on the image bearing member; and
the developing device of claim 8.

11. An image forming apparatus, comprising:
an image bearing member on which a latent image is to be formed;
a latent image forming section for forming the latent image on the image bearing member; and
the developing device of claim 9.
